(19) United States
(12) Patent Application Publication
(10) Pub. No.: US 2016/0223639 A1
(43) Pub. Date: Aug. 4, 2016

(54) WIRELESS SYSTEMS AND METHODS

(71) Applicant: Intel Corporation, Santa Clara, CA (US)

(72) Inventors: Alexei DAVYDOV, Nizhny Novgorod (RU); Seunghee HAN, San Jose, CA (US)

(21) Appl. No.: 14/836,213

(22) Filed: Aug. 26, 2015

Related U.S. Application Data
(60) Provisional application No. 62/109,505, filed on Jan. 29, 2015.

(51) Int. Cl. G01S 5/04; H04W 4/02

(52) U.S. Cl. CPC G01S 5/04; H04W 4/023

(57) ABSTRACT

Embodiments relate to wireless systems and methods having improved positioning using at least one of aggregated multiple component carriers bearing respective positioning signals and associated quasi co-location information.

### CROSS-REFERENCE TO RELATED APPLICATION

This application claims priority to U.S. Provisional Patent Application No. 62/109,505, filed Jan. 29, 2015, the content and disclosure of which is hereby incorporated by reference in its entirety.

### BACKGROUND

Some countries have prescribed user equipment (UE) positioning requirements for mobile operators. For example, the Federal Communications Commission (FCC) requires all mobile operators in the USA to provide location information of a user equipment following an emergency call made from that user equipment. More particularly, if the user equipment is outdoors, the FCC requirements require the location of the user equipment to be determined to within an accuracy of 50 m in 67% of all emergency calls, with 80% of emergency calls having user equipment being located to an accuracy of 150 m, rising to 90% over time.

Many systems use a Global Navigation Satellite System (GNSS) to determine position information. Most user equipment has GNSS capability. However, the FCC is considering extending current E911 location requirements to indoor situations. GNSS based location techniques can be less effective indoors due to the satellite signals being undetectable due to attenuation or being blocked entirely. Additionally, the FCC also requires indoor position information to be determined to within a 3 m resolution vertically for 67% of emergency calls originating indoors, rising to 80% within 5 years.

### BRIEF DESCRIPTION OF THE DRAWINGS

Aspects, features and advantages of embodiments will become apparent from the following description given with reference to the appended drawing in which like numerals denote like elements and in which:

FIG. 1 illustrates a wireless system according to an embodiment;

FIG. 2 shows positioning using a wireless system according to an embodiment;

FIG. 3 depicts multiple carrier component position signalling according to an embodiment;

FIG. 4 illustrates multiple carrier component position signalling according to an embodiment;

FIG. 5 shows multiple carrier component signalling according to an embodiment;

FIG. 6 depicts a receiver according to an embodiment;

FIG. 7 shows positioning signalling according to an embodiment;

FIG. 8 illustrates positioning signalling according to an embodiment;

FIG. 9 illustrates a UE according to an embodiment;

FIG. 10 depicts a UE system according to an embodiment;

FIG. 11 shows a UE according to an embodiment;

FIG. 12 illustrates a flow chart according to an embodiment;

FIG. 13 depicts a flow chart according to an embodiment; and

FIG. 14 shows a UE according to an embodiment.

### DETAILED DESCRIPTION OF THE EMBODIMENTS

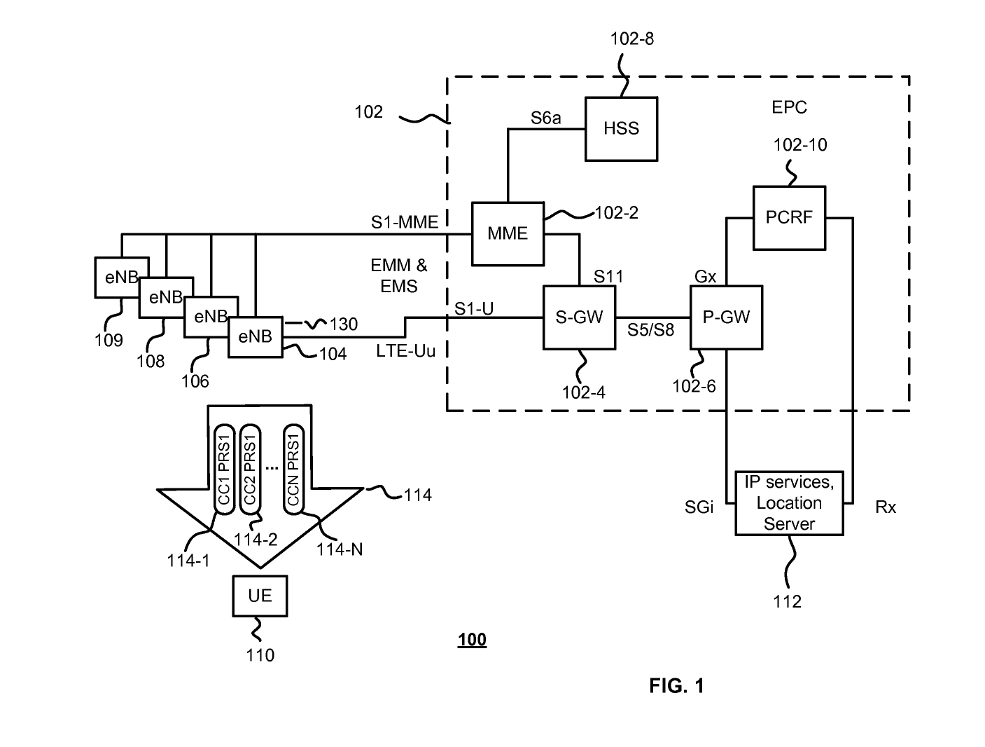

FIG. 1 shows a communication system such as, for example, an Evolved Packet System (EPS) 100. The EPS 100 comprises an Evolved Packet Core (EPC) 102, a number of eNodeBs (eNB) 104 to 109, a user equipment (UE) 110 and an operator packet data network 112 comprising a location server.

The EPC 102 has a mobile management entity (MME) 102-2. The EPC 102 also comprises a serving gateway (S-GW) 102-4 and a packet data network gateway (P-GW) 102-6. The S-GW 102-4 is operable to exchange packets with the eNBs 104 to 109. The eNBs 104 to 109 can be configured to serve one or more than one UE such as the UE 110 shown. The S-GW 102-4 operates, in effect, as a router supporting data exchange between the UE 110 and the P-GW 102-6. The P-GW 102-6 serves as a gateway to external packet data networks such as, for example, the network 112 and, in particular, a location server. The P-GW 102-6 also performs other functions such as address allocation, policy enforcement, packet filtering and routing. It can be appreciated that the packet data network gateway 102-6 communicates with the external packet data network 112 via an SGi interface.

The MME 102-2 performs signaling such that data packets do not pass through the MME 102-2, which decouples data from signaling to support developing capacity for signaling and data separately. The MME 102-2 is operable to control many aspects of UE 110 engagement such as, for example, paging the UE 110, tracking area management, authentication, gateway selection, roaming, security and the like.

The eNBs 104 to 109 are responsible for providing an air interface, LTE-Uu, via which the UE 110 can transmit and receive packets. The eNBs 104 to 109 perform various functions such as, for example, admissions control to allow the UE 110 access to the EPC 102 and radio resource management.

The eNBs 104 to 109 and the MME 102-2 communicate via an S1-MME interface. Optionally, and not shown, the eNBs 104 to 109 can be connected to one another or to one or more other eNBs either directly via an X2 interface or indirectly via the S1-MME interface.

The EPC 102 can comprise a home subscriber server (HSS) 102-8. The HSS 102-8 is a centrally accessible database containing subscriber data associated with one or more than one UE such as, for example, the UE 110.

The various interfaces described above can be implemented to exchange data between the UE 110 and the P-GW 102-6 using user plane protocols such as, for example, GPRS tunneling protocol user part (GTP-U), and, for example, Generic Routing Encapsulation (GRE); the latter can be used to realise an S5/S8 interface between the S-GW 102-4 and the P-GW 102-6.

The EPS 100 uses a plurality of signaling protocols. Air interface signaling, via which the eNBs 104 to 109 influence or otherwise control the radio resources used by the UE 110, is realised using a radio resource control (RRC) protocol. The S1-MME link or interface is realised using the S1 application protocol (S1-AP).

The MME 102-2 controls the UE 110 using two air interface non access stratum protocols, which are the EPS session management (ESM) protocol, for controlling data streams associated with the external packet data network 112, and the EPS mobility management (EMM) protocol, for managing the internal operation of the EPC 102. EMM and EMS messages are exchanged with the UE 110 using RRC and S1-AP messages using the S1-MME and LTE-Uu interfaces.

The S11 interface signaling and the S5/S8 interface signaling are implemented using the GPRS tunneling protocol control part (GTP-C).

The EPC 102 can also comprise a Policy Control Rule Function (PCRF) network entity 102-10. The PCRF 102-10 is responsible for establishing a number of performance objectives. Examples of the performance objectives can comprise at least one of quality of service (QoS) and charging goals for each session based on a respective or committed service level per UE and service type.

The network 100 can be configured to determine UE position information using a number of positioning techniques. The positioning techniques can comprise one or more than one of Assisted Global Navigation Satellite systems (A-GNSS), observed Time Difference of Arrival (OTDOA) and Enhanced Cell ID (ECID).

In LTE-A, OTDOA is supported by measuring, at the UE, the time difference of arrival of a number of signals and/or to at least perform measurements associated with UE position. The signals can be, for example, positioning reference signals (PRS) 114 transmitted by one or more than one eNB of the plurality of eNBs 104 to 109. The PRS signals 114 are configured and communicated to the UE 110 via higher layer signaling by providing PRS data associated with at least one or more than one of the following: a carrier index where the PRS is transmitted, PRS bandwidth, number of consecutive subframes for PRS transmissions, PRS transmission periodicity/subframe offset and PRS muting sequence taken jointly and severally in any and all permutations.

The PRS signals 114 are provided by one or more than one eNB of the plurality of eNBs 104 to 109. It can be appreciated that the PRS signals 114 can comprise a plurality of position reference signals. Embodiments are provided in which the position reference signals are the same and are carried by respective component carriers. In the illustrated embodiments a plurality of component carriers is shown as comprising N component carriers 114-1 to 114-N. Embodiments can be realised in which contiguous component carrier aggregation is used to transmit multiple instances of the position reference sequences using respective resource elements. It will be appreciated that the PRS signals 114, using contiguous component carrier aggregation will result in the PRS signals occupying a wider contiguous bandwidth as compared to a single component carrier.

The component carriers are selected so that the component carriers are quasi co-located as provided for in, for example, TS 36.211, v.11.1.0. Since the PRS signals are quasi co-located, there will be a predeterminable relationship or connection between different reference signals with respect to one or more than one physical characteristics such as, for example, at least one or more than one of: Doppler shift, Doppler spread, average delay, delay spread and average gain taken jointly and severally in any and all permutations. If the PRS signals 114 can be considered as being quasi co-located due to, for example, co-location of the transmission, measurements associated with such one or more than one of the PRS signals 114-1 to 114-N, or an associated one or more than one parameter of the one or more than one physical characteristic, can be assumed to be the same when processing another PRS signal of the plurality of PRS signals 114-1 to 114-N.

For example, a UE configured in any of transmission modes 1-10 may assume the antenna ports 0-3 of a serving cell are quasi co-located as prescribed in, for example, TS 36.211 v.11.1.0 with respect to a number of physical characteristics, such as, channel characteristics like, for example, delay spread, Doppler spread, Doppler shift, average gain and average delay taken jointly and severally in any and all permutations. Therefore, the delay spread, Doppler spread, Doppler shift, average gain and average delay estimated for signals on antenna port 0 may be reused or assumed the same as for signals on antenna ports 1, 2 and 3. Such assumptions can provide noticeable implementation advantages for time and frequency synchronization.

Therefore, embodiments can use quasi co-location of PRS signals to improve performance. For example, embodiments can be realised in which measurements of the one or more than one physical characteristic can be performed for selectable PRS signals on respective component carriers and an average value can be determined and used for subsequent signal processing on the assumption that the PRS signals have quasi co-located origins. Therefore, embodiments can be realised that determine an average estimate of one or more than one physical characteristic derived from PRS signals associated with quasi co-located antenna ports. For example, one or more than one of delay spread, Doppler spread, Doppler shift, average gain and average delay, estimated PRS signals on a predetermined antenna port, such as, for example, antenna port 6, taken jointly and severally in any and all permutations, may be processed jointly to improve estimation accuracy.

Alternatively, or additionally, embodiments can realise an effective increase the bandwidth of PRS signal transmissions beyond the existing limit of 100 RBs or 20 MHz as a consequence of the PRS signals 114 being quasi co-located PRS signals carried by multiple respective component carriers together with respective quasi co-located information or signalling. Therefore, a UE according to an embodiment, having received such quasi co-located information or signalling, can process the PRS signals over a larger bandwidth, such as, for example, the bandwidth of at least two component carriers bearing PRS signals of all of the component carriers bearing PRS signals. Consequently, it will be appreciated that the one or more than one physical characteristic can be estimated over a larger bandwidth. For example, it will be appreciate that the timing estimation (or average delay) for the PRS signals may be performed effectively over larger system bandwidth relative to the bandwidth of a single PRS signal.

Additionally, any and all embodiments can utilise a predetermined sampling period that is smaller than a sampling period used for such a smaller bandwidth signal associated with a single PRS signal.

Therefore, embodiments facilitate positioning measurements such as, for example, OTDOA measurements or Reference Signal Time Difference (RSTD) measurements, on PRS signals over a wider bandwidth and/or a higher sampling frequency than the existing bandwidth of 20 MHz or 100 RBs or associated sampling frequency.

Increasing the bandwidth of the PRS signal transmission beyond the existing limit of 100 RBs or 20 MHz stems from using multiple component carriers with PRS signals transmissions on each of the component carrier together with quasi co-location information or signalling associated with the PRS signal transmitted on different component carrier but from the same transmission point.

The quasi co-location information or signalling for the PRS signals can comprise at least one or more than one further identifier such as, for example, a physical cell ID and frequency band, associated with another PRS signal that a receiving UE may assume as being quasi co-located with respect to the one or more than one physical characteristic such as, for example, average delay, channel gain, Doppler shift, Doppler spread and delay spread taken jointly and severally in any and all permutations.

Embodiments can be realised in which the quasi co-location information or signalling can be provided as a part of OTDOA-ReferenceCellInfo or PRS assistance information, as defined in TS 36.355, v12.4.0 or earlier, as extended according to embodiments. The quasi co-location relationship can relate to one or more than one parameter that is prescribed in TS 36.355 as a basis for establishing such a quasi co-location connection or relationship. Embodiments can be realised in which the one or more than one parameter comprises at least a pair of parameters such as, for example, a physical cell ID and frequency band of the quasi co-located PRS signal. It will be appreciated that embodiments are not limited thereto. In the embodiment described below, which is an example of higher layer signalling, a data structure, PRS-Info, is extended to comprise a parameter “qclCellId” that indicates the cell identity of another cell that has at least one quasi co-located PRS signal transmission relative to a current cell or eNB. Therefore, the PRS configuration information can be provided by the eNBs 104 to 109 to the UE 110 using an information element (IE) comprising PRS data associated with the PRS configuration of a cell of a respective eNB. For example, such an information element could, therefore, be

| | |
|---|---|
| -- ASN1START | |
| PRS-Info ::= SEQUENCE { | |
| prs-Bandwidth | ENUMERATED { n6, n15, n25, n50, n75, n100, ... }, |
| prs-ConfigurationIndex | INTEGER (0..4095), |
| numDL-Frames | ENUMERATED {sf-1, sf-2, sf-4, sf-6, ...}, |
| ..., | |
| prs-MutingInfo-r9 | CHOICE { |

| | po2-r9 | BIT STRING (SIZE(2)), |
|---|---|---|
| | po4-r9 | BIT STRING (SIZE(4)), |
| | po8-r9 | BIT STRING (SIZE(8)), |
| | po16-r9 | BIT STRING (SIZE(16)), |
| | ... | |
| } | OPTIONAL | -- Need OP |
| | qclCellId | INTEGER (0...503) |

}
-- ASN1STOP

where the PRS-Info fields comprise:

qclCellId comprises the cell identity of another cell having at least one or more than one co-located PRS signal transmission relative to a PRS signal transmissions of a current cell associated with the PRS-Info IE. It can be appreciated that the qclCellId can take integer values falling within a predetermined range. Embodiments can be realised in which the predetermined range is 0 to 503;

additionally, further fields can comprise one or more than one of the following taken jointly and severally in addition to the above qclCellId:

prs-Bandwidth, which specifies the bandwidth that is used to configure the position reference. The enumerated values are specified in terms of number of resource blocks, for example, n6 corresponds to 6 resource blocks, n15 corresponds to 15 resource blocks and so on, which also, in turn, define 1.4, 3, 5, 10, 15, and 20 MHz bandwidths;

prs-ConfigurationIndex, which specifies the positioning reference signal's configuration index, I_{PRS};

numDL-Frames, which specifies the number of consecutive downlink subframes NPRS with positioning reference signals. The enumerated values define 1, 2, 4 or 6 consecutive subframes; and

prs-MutingInfo, which is a field that specifies the PRS muting configuration of the cell. The PRS muting configuration is defined by a periodic PRS muting sequence with periodicity TREP, where TREP, counted in terms of the number of PRS positioning occasions, can take values 2, 4, 8 or 16, which is also the length of the selected bit string that represents the PRS muting sequence. If a bit in the PRS muting sequence is set to “0”, then the PRS is muted in the corresponding PRS positioning occasion. A PRS positioning occasion comprises a number, NPRS, of downlink positioning subframes as defined in 3GPP TS36.211, Evolved Universal Terrestrial Radio Access (E-UTRA), Physical Channels and Modulation, V12.5.0 or earlier. The first bit of the PRS muting sequence corresponds to the first PRS positioning occasion that starts after the beginning of the assistance data reference cell SFN=0. The sequence is valid for all subframes after the target device has received the prs-MutingInfo. If this field is not present, the target device may assume that the PRS muting is not in use for the cell.

For the PRS signals transmitted on different cells and indicated as quasi co-located, embodiments can be realised that influence the PRS configuration information. For example, for such quasi co-located cells, the prs-ConfigurationIndex, numDL-Frames, prs-MutingInfo, taken jointly and severally in any and all permutations, may be assumed to be the same among the quasi co-located PRS signals.

Although the above embodiments have been described with reference to the identifier associated with the quasi co-located PRS signal transmissions being a cell identifier, embodiments are not limited to using such an identifier. Embodiments can be realised in which some other identifier is used that can be associated with one or more than one quasi co-located transmission.

The embodiments have been described with reference to using a PRS signal the basis of positioning or position measurements. Embodiments can alternatively, or additionally, use some other signal as the basis of positioning or position measurements such as, for example, a different reference signal. Embodiments can be realised in which such quasi co-located signals can be or can comprise one or more than one Cell Specific Reference (CRS) signal.

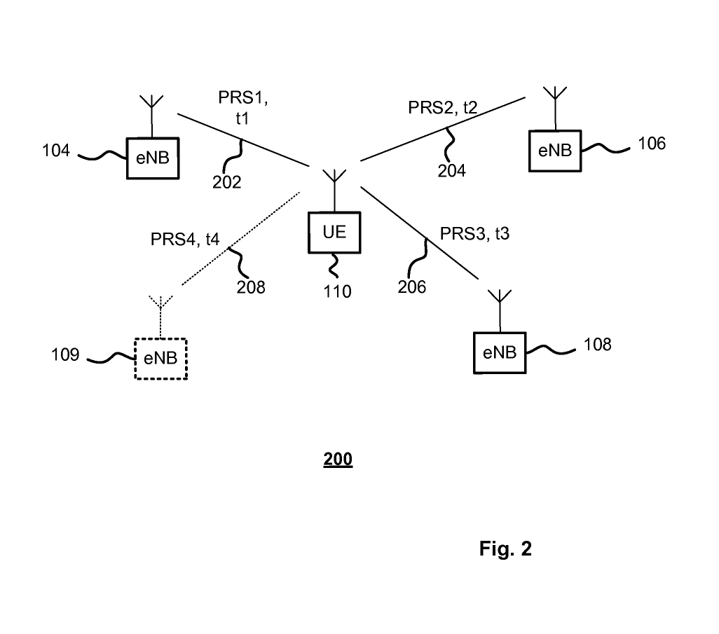

FIG. 2 shows a view 200 of PRS signal 114 transmission according to an embodiment using an OTDOA positioning technique. The UE 110 selects one eNB, such as the eNB 104, as a reference eNB and measures the difference in the time of arrival of a PRS signal from another eNB relative to the time of arrival of a corresponding PRS signal from that reference eNB 104. A plurality of times of arrival for respective PRS signals is, or can be, determined. The position of the UE 110 can be determined from the differences in the times of arrival of corresponding PRS signals by, for example, determining the points of intersection of hyperbola associated with the differences in the times of arrival. It can be appreciated that a first PRS signal 202 has a first time of arrival at the UE 110 of t1. A second PRS signal 204 has a respective time of arrival of t2. A third PRS signal 206 has a respective time of arrival of t3. It will be appreciated that the time differences between the times of arrival such as, for example, t1−t2, t1−t3, t2−t3 define respective hyperbola. The points of intersection of the hyperbola define the position of the UE 110.

Therefore, knowing the position of the eNBs 104 to 108 would allow the UE position in a plane to be determined. Preferably, a further eNB 109 also transmits a respective PRS signal having a respective time of arrival t4, which allows the position of the UE 110 in 3D space to be determined from the equations of respective hyperboloids associated with the differences in the times of arrival.

It will be appreciated that the one or more than one PRS signal of the PRS signals 202 to 208 can be embodiments of the multi-component carrier PRS signals 114 described above. Therefore, for example, one or more of the PRS signals 202 to 208, taken jointly and severally in any and all permutations, can comprise multiple quasi co-located PRS signals conveyed by respective component carriers.

It can be appreciated from FIG. 2 that multiple instances of the PRS signals are used in determining position. Embodiments of the PRS signal can be realised using, for example, the positioning reference sequence defined in 3GPP TS 36.221, section 6.10.4.1. However, other signals can be used in OTDOA positioning.

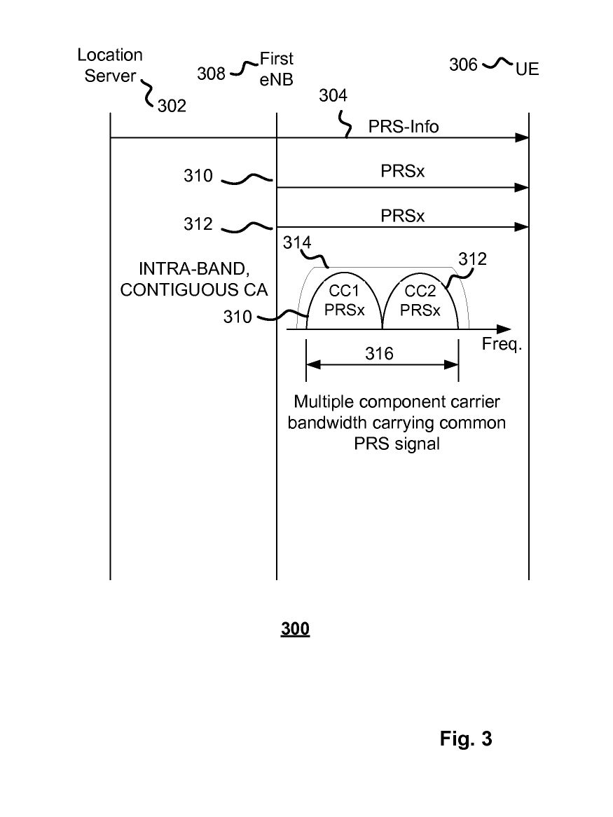

FIG. 3 shows a view 300 of a pair of contiguous component carriers bearing reference signals. The reference signals are PRS signals 114, 202 to 208. A first embodiment comprises a location server 302 configured to transmit quasi co-location information 304 to a user equipment 306. The UE can be an embodiment of the UE 110 described herein. Embodiments can be realised in which the quasi co-location information 304 is transmitted to the user equipment transparently via a first eNB 308. The first eNB 308 comprises circuitry to transmit at least two quasi co-located PRS signals 310 and 312 to the UE 306.

An embodiment of the quasi co-location information 310 is the PRS-Info IE described above or herein. It can be appreciated that the two quasi co-located PRS signals 310 and 312 are transmitted as intra-band contiguous component carriers 314, with the sampling or processing of those intra-band non-contiguous component carriers spanning a bandwidth associated with those component carriers. Embodiments can be realised in which the two PRS signals 310 and 312 are intra-band non-contiguous component carriers, with the sampling or processing of those intra-band non-contiguous component carriers spanning a bandwidth associated with those component carriers. The two PRS signals 310 and 312 occupy a bandwidth 316 that is greater than the bandwidth of a single PRS signal.

The UE 306 is arranged to process the two PRS signals 310 and 312 by sampling the complete bandwidth 316 occupied by the two PRS signals 310 and 312 as opposed to processing in a manner that samples across two separate bandwidths of the PRS signals 310 and 312. Although the bandwidth over which the UE 306 processes the two PRS signals 310 and 312 is shown as relating to the lowest frequency of the first PRS signal 310 and the highest frequency of the second PRS signal 312, embodiments are not limited to processing the precise bandwidth occupied by the PRS signals 310 and 312. Embodiments can be realised in which some other bandwidth that is greater than the bandwidth of a single PRS signal can be processed in addition to or as an alternative to the foregoing bandwidth 316. Such a bandwidth can be greater than the bandwidth spanned by the pair of PRS signals 310 and 312. Additionally, or alternatively, the sampling frequency used for sampling the bandwidth occupied by the two PRS signals or multiple component carriers is arranged to be higher than a sampling frequency used to sample a bandwidth occupied by a single PRS signal or a single component carrier.

Furthermore, although embodiment have been illustrated using a pair of PRS signals 310 and 312, embodiments can be realised that use a plurality of PRS signals such as three or more PRS signals. In such embodiments, the user equipment is arranged to process the PRS signals across the bandwidth spanned by the plurality of PRS signals or a bandwidth associated with at least two or more PRS signals of such a plurality of PRS signals.

Embodiments can be realised in which an eNB is configured or comprises circuitry to transmit the quasi co-located PRS signals using carrier aggregation as indicated above. For example, an eNB or cell can be arranged to apply carrier aggregation to the quasi co-located PRS signals to realise intra-band contiguous carrier aggregation and the UE equipment can be signaled using a respective quasi co-location information IE to process the multiple PRS signals conveyed by the components by sampling across the whole of the bandwidth associated with the component carriers bearing the PRS signals, or at least to sample over a bandwidth of the multiple component carriers bearing PRS signals that is greater than the bandwidth of a single component carrier bearing a respective PRS signal.

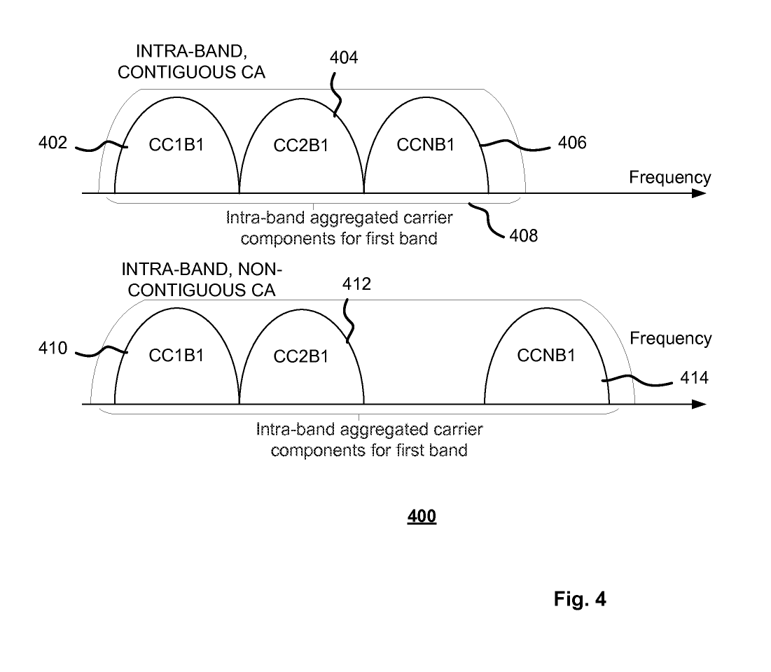

Referring to FIG. 4, there is shown a view 400 of embodiments of multiple component carrier transmissions in which two or more component carriers bear positioning signals such as, for example, the reference signals, PRS, CRS, or other positioning signals described herein. It can be appreciated that the multiple component carrier transmissions can comprise a number of component carriers such as, for example, first 402, second 404 and third 406 component carriers. The component carriers 402 to 406 are aggregated or arranged to occupy a contiguous bandwidth 408. Embodiments of the contiguous bandwidth of component carriers can be realised using intra-band contiguous carrier aggregation in which the aggregated signals are PRS signals.

The three component carriers 402 to 406 are arranged to be quasi co-located with respect to one or more than one physical characteristic using, for example, carrier aggregation.

It will be appreciated that embodiments are not limited to using three component carriers 402 to 406. Embodiments can be realised in which some other number of component carriers is used. For example, embodiments can be realised in which at least two component carriers are used. The bandwidth of the aggregated component carriers bearing respective positioning signals will be greater than the bandwidth of a single positioning signal or a single component carrier.

Although the embodiments described with reference to FIG. 4 use intra-band contiguous component carriers, embodiments are not limited thereto. Embodiments can be realised in which intra-band non-contiguous component carriers are used by the UE 110 providing the bandwidth of the component carriers that are processed such as, for example, sampled, is greater than the bandwidth of a single PRS signal or a single component carrier. Such an intra-band non-contiguous aggregated component carrier embodiment is shown in the lower portion of FIG. 4, where it can be appreciated that a first plurality of contiguous component carriers 410 and 412, bearing a positioning signal, are positioned in the frequency domain relative to a non-contiguous component carrier 414.

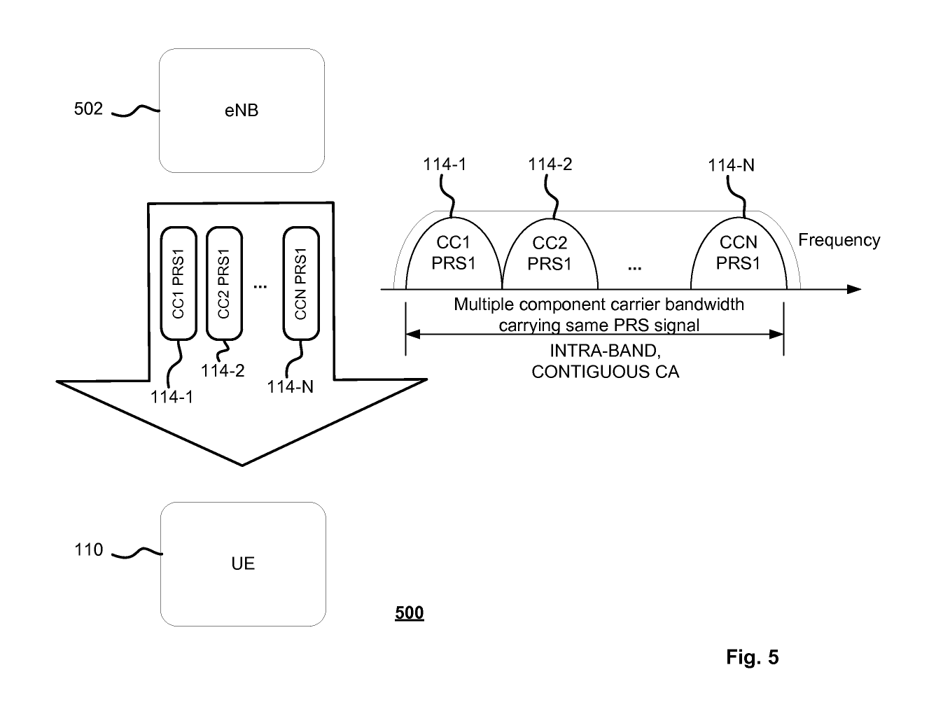

Referring to FIG. 5, there is shown a view 500 of intra-band component carrier aggregation in which a plurality of quasi co-located component carriers bear respective positioning signals. It can be appreciated that the positioning signals are, firstly, the same and, secondly, that every component carrier of the band bears that same signal. However, embodiments are not limited thereto. Embodiments can be realised in which two or more than two component carriers, intended for a respective UE, have the same positioning signal. Other sets of two or more than two component carriers can bear respective positioning signals intended for a different UE.

It can be appreciated that an eNB 502, which can be one or more than one of the eNBs 104 to 109 described herein, is transmitting a plurality of quasi co-located component carriers 114-1 to 114-N to the UE 110. The embodiment illustrated shows intra-band contiguous component carrier aggregation in which each component carrier bears, or in which at least two component carriers bear, the same positioning signal.

In advance of transmitting the positioning signals 114-1 to 114-N, a network apparatus such as, for example, the location server 112 will or can have transmitted associated quasi co-location information to the UE 110, via the eNB 502. The eNB 502 can be an embodiment of one of the eNBs 104 to 109 described herein.

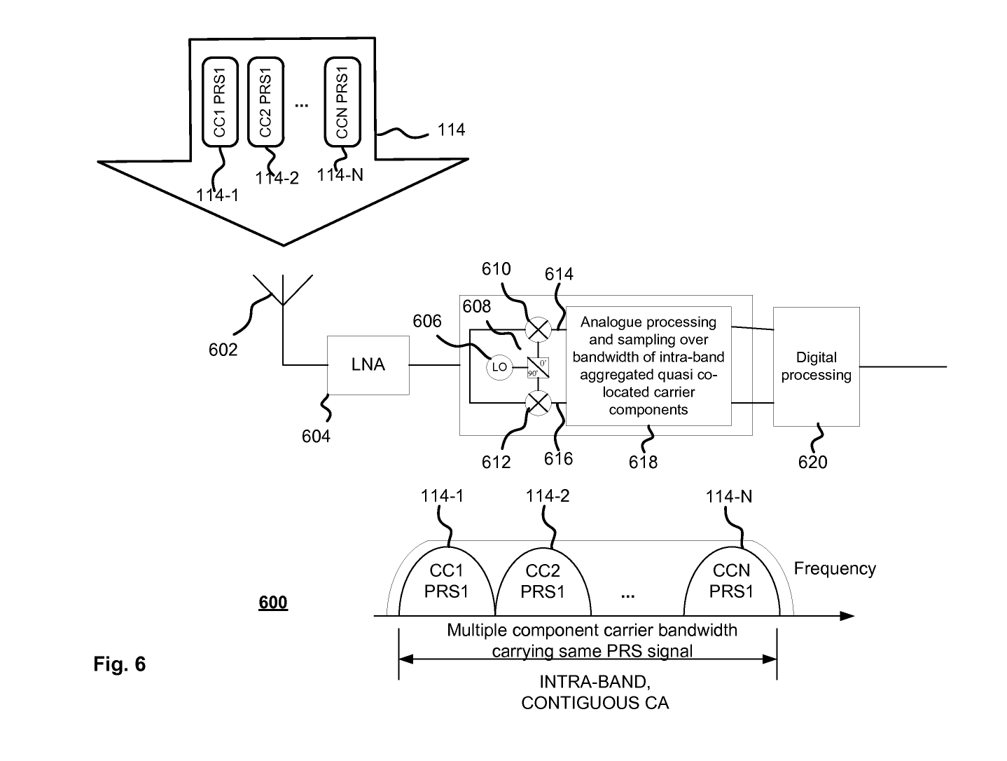

FIG. 6 depicts a view 600 of receiver for processing signals according to embodiments. The receiver comprises at least one antenna 602 for receiving the intra-band contiguous carrier aggregated component carriers 114. Embodiments can be realised in which multiple antennas are used, as would be the case for MIMO embodiments. As indicated above, the component carriers 114-1 to 114-N comprise two or more positioning signals. In the illustrated embodiment, the component carriers 114-1 to 114-N each bear a respective PRS signal or a respective instance of the same PRS signal. At least one of the PRS signals and the component carriers are quasi co-located. The nature of the quasi co-location is communicated to the receiver by a cell or eNB such as one or more than one eNB of the eNBs 104 to 109 described herein. The cell or eNB forwards, transparently, the quasi co-location information output by network apparatus such as, for example, the location server 112.

The quasi co-located carrier aggregated positioning signals 114 are processed by a low noise amplifier (LNA) 604 before IF and baseband processing using a local oscillator 606, a phase shifter 608 to induce a phase shift of pi/2 and a pair of mixers 610 and 612 arranged to produce I & Q channels 614 and 616.

Analogue to digital conversion is performed by an analogue processor 618. The analogue processor 618 comprises circuitry configured to sample the full bandwidth of the intra-band aggregated quasi co-located carrier components bearing the PRS signals, or at least a bandwidth that exceeds that of a single PRS signal. It will be appreciated that the analogue processor 618 will be arranged to sample the intra-band aggregated quasi co-located component carriers at a given frequency that, in turn, will influence the same duration and, therefore, any timing estimation or timing accuracy derived from the sampled bandwidth. For a single PRS signal, having a bandwidth of 20 MHz, the sampling period will be 50 ns, which corresponds approximately to a timing estimation or position resolution of approximately 15 m. However, embodiments comprise processing circuitry arranged to sample a larger bandwidth using a corresponding higher sampling frequency that, in turn, will lead to improved timing estimation resolution and improved position resolution. An embodiment that uses two PRS signals carried by respective component carriers such as, for example, a pair of component carriers 114-1 and 114-2 could span 40 MHz, with a respective sampling period of 25 ns and a position resolution of 7.5 m. The analogue processor 618 outputs digitized data for further processing by a digital signal processor 620.

It will be appreciated that the accuracy of the signal processing is increased or improved by processing the multiple component carriers across their bandwidth as compared to processing a single PRS across its narrower bandwidth. It will be appreciated, therefore, that the sampling rate varies with the bandwidth of the signal to be sampled. Therefore, one or more than one embodiment, or all embodiments, described herein are arranged to increase the sampling rate with increasing bandwidth. As indicated above, if the bandwidth doubles, the sampling period halves. Therefore, any and all embodiments can vary the sampling period with the number of component carriers to be sampled.

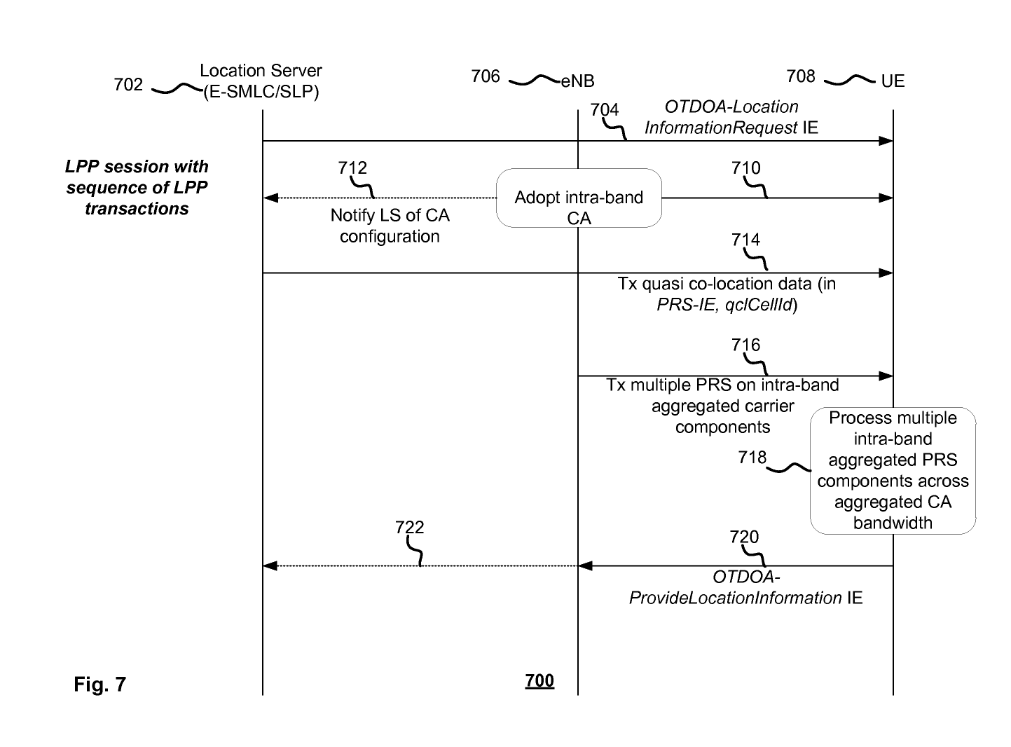

Referring to FIG. 7, there is shown a view 700 of location signalling according to an embodiment. The signalling is controlled by a network apparatus such as, for example, the location server 702, which can be, for example, an embodiment of the above location server 112. Embodiments are provided in which a request 704 for positioning information can be generated by the location server 702. An embodiment of the request 704 can comprise, for example, an OTDOA-LocationInformationRequest IE.

The request is transparently handled by an eNB 706, which can be an embodiment of one of the above eNBs 104 to 109. The eNB 706 forwards the request 704 for positioning information to a UE 708. The UE 708 can be a UE 110 such as described herein.

The eNB 706 instructs, at 710, the UE 708 to process subsequently received positioning signals on the assumption that they have been conveyed at least using intra-band multiple component carriers each containing a positioning signal such as, for example, a least of one a PRS, CRS signal or other reference signal.

Optionally, the eNB 706 can also inform, at 712, the location server 702 that intra-band multiple component carriers are being used to convey the positioning signals.

Quasi co-location information is, or can be, also transmitted by the location server 702 to the UE 708 at 714. Subsequently, the intra-band multiple component carriers signal containing the positioning signals is transmitted, at 716, to the UE 708 by the eNB 706.

The UE 708 processes the received multiple positioning signals at 718, as indicated herein, particularly, with reference to FIG. 6. Embodiments are provided in which the positioning signals are conveyed using intra-band aggregated component carriers. The bandwidth of signals resulting from the carrier aggregation will be greater than the bandwidth of a single PRS signal.

Once the UE 708 has processed the positioning signals conveyed by the intra-band component carriers, the UE 708 transmits, at 720, associated OTDOA measurement information to the eNB 706. An embodiment of the position measurement information can be, for example, an OTDOA-ProvideLocationInformation IE. The eNB 706 forwards the position measurement information to the location server 702 at 722. The location server 702 can determine the position of the UE 708 from the position measurement information received at 722.

It will be appreciated that the eNB 706 transparently forwards, at 722, the associated position measurement information to the location server 702.

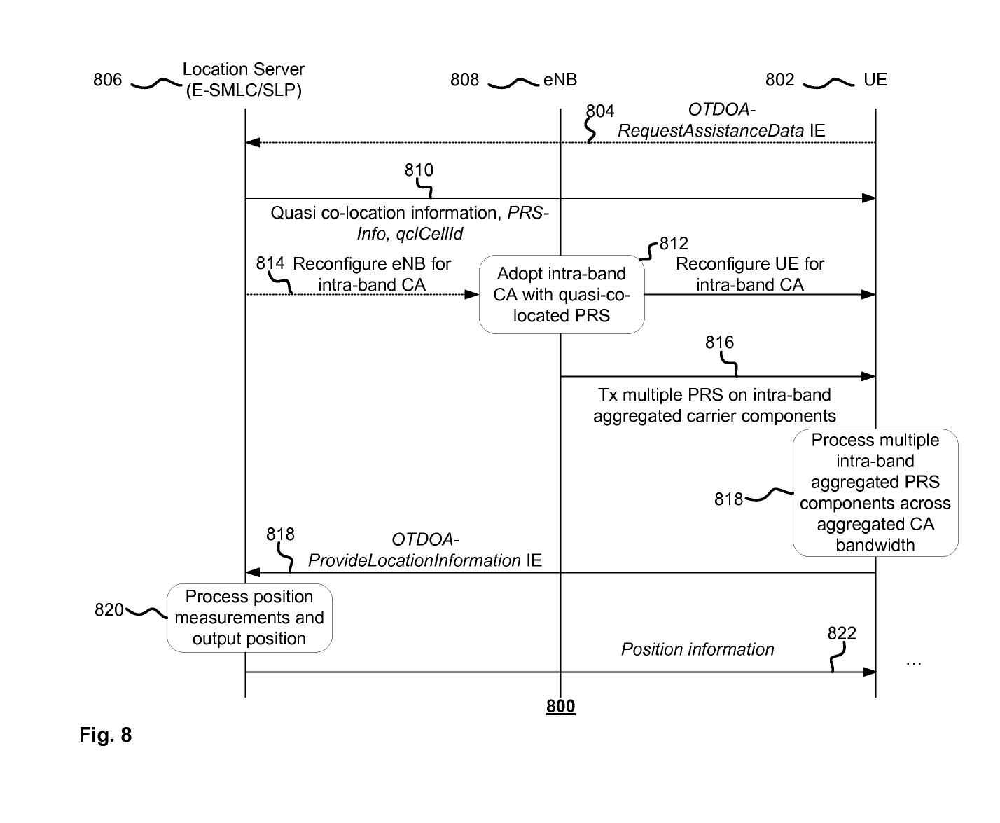

FIG. 8 shows a view 800 of positioning signalling according to an embodiment. A UE 802, such as UE 110, transmits a request 804 for assistance in determining position information associated with the UE 802. The request 804 for assistance is transmitted to a location server 806 transparently via an eNB 808, such as, for example, one of the above described eNBs 104 to 109. The location server 806 can be an embodiment of the above-described location server 112. An embodiment of such a request can comprise, or be, an OTDOA-RequestAssistanceData IE.

As indicated, the eNB 808 transparently forwards the request to the location server 806.

The location server 806 transmits quasi co-location information associated with positioning signals to the UE 802 at 810. Embodiments of the quasi co-location information associated with the positioning signals can be, for example, PRS-Info according to embodiments.

The eNB 808, in response to receiving and forwarding the quasi co-location information or in response to receiving the request 804, instructs the UE 802 to adopt intra-band carrier aggregation at 812. Alternatively, or additionally, the location server 806 could instruct, at 814, the eNB 808 to adopt such intra-band carrier aggregated transmission of the positioning signals.

The eNB 808 transmits multiple component carriers conveying respective positioning signals to the UE 802 at 816. The respective positioning signals can represent instances of the same positioning signal.

The UE 802 receives and processes the intra-band component carriers at 818. It will be appreciated that the processing comprises processing the component carriers across the bandwidth spanned by the component carriers, which is greater than the bandwidth spanned by a single positioning signal.

Optionally, the UE 802 can transmit position measurement information or position information to at least one of the location server 806 and the eNB 808 at 818 or to some other network apparatus. As indicated, embodiments can be realised in which the reconfiguration to adopt intra-band carrier aggregated transmission of positioning signals with quasi co-located information can be optionally instigated by the location server 806 providing signalling 814 to that effect.

Embodiments can be realised in which the location server 806 receives the position information from the UE 820 or receives position measurement information from the UE 802 at 818 and processes that information at 820. The processing can comprise determining a position associated with the UE 802. Optionally, the location server 806 can transmit the results of the processing at 820 to the UE 802 at 822. The results can comprise position information associated with the UE 802.

Embodiments expressed herein have been described with reference to providing an increased bandwidth over which signal processing can be conducted. The bandwidth of the aggregated component carriers bearing the positioning signals is greater than a first measure. Embodiments can be realised in which the first measure is greater than a predetermined number of MHz or greater than a predetermined number of resource blocks (RB). Embodiments can be realised in which the predetermined number of MHz is 20 MHz. Embodiments can be realised in which the predetermined number of RBs is 100. Still further embodiments can be realised in which the first measure is greater than or equal to 40 MHz or greater than or equal to 200 RBs. Still further embodiments can be realised in which the first predetermined measure is greater than the bandwidth of a single positioning signal, preferably, greater than the bandwidth of multiple positioning signals.

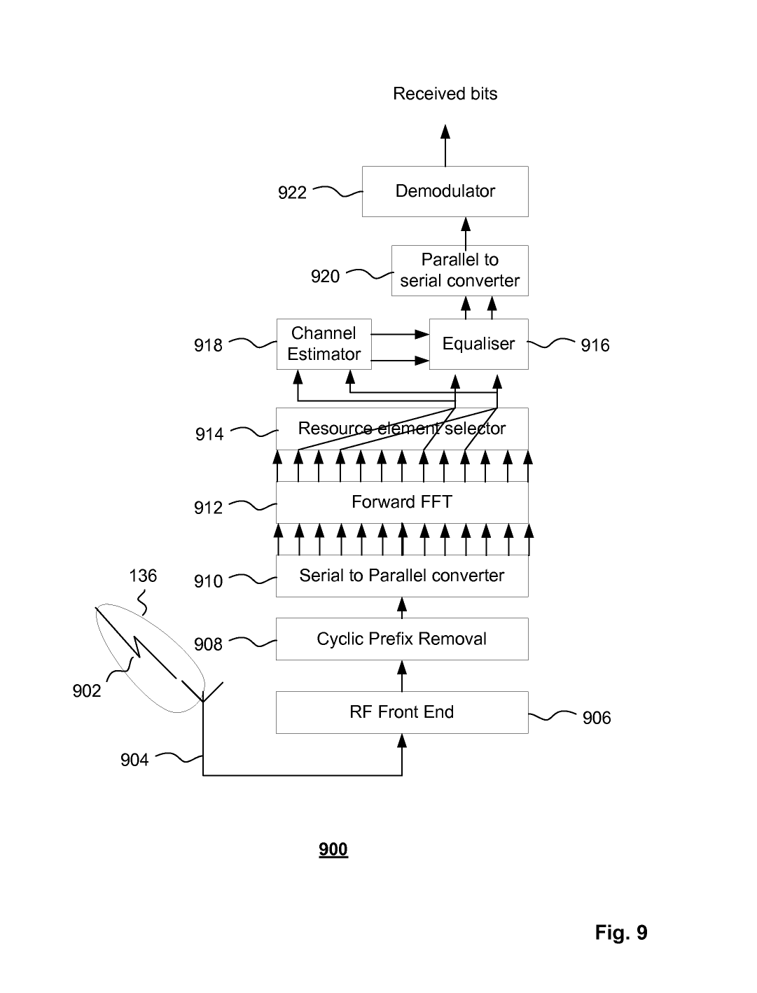

Referring to FIG. 9, there is shown schematically a view 900 of a part of a user equipment (UE), such as UE 110, for processing a received signal 902 such as the multiple component carrier signal 114.

The signal 902 is received using at least one or more than one antenna 904, and, in some examples, is received by multiple antennas. The received signal 902 is processed by an RF front end 906 such as, for example, the receiver described above with reference to FIG. 6.

Cyclic prefix removal circuitry 908 is arranged to remove any cyclic prefixes. The signal 902 is then passed through a serial to parallel converter 910, which outputs associated symbols. The symbols output by the serial to parallel converter 910 are processed by forward Fast Fourier Transform circuitry 912. The output of the FFT circuitry 912 is passed to a resource element selector 914, which selects the radio resources intended for the receiving UE for further processing and ignores other radio resources since they may be intended for other UEs.

The selected radio resources are processed by an equalizer 916 and a channel estimator 918. The channel estimator 918 processes the selected radio resources with a view to influencing the operation of the equalizer 916. The output of the equalizer 916 is converted into serial form, via a parallel to serial converter 920. The parallel signals are then processed by a demodulator 922 that is adapted to demodulate any received data.

It will be appreciated that at least one or more of the RF front end 906, cyclic prefix module 908, serial to parallel converter 910, FFT module 912, resource element selector 914, equaliser 916, channel estimator 918, parallel to serial converter 920 and demodulator, taken jointly and severally in any and all combinations, are examples of one or more than one processing module or processing circuitry.

Embodiments can, therefore, be realised in which a user equipment, such as any or all of the user equipments described herein, can process a carrier aggregated signal comprising a plurality of aggregated component carriers in which at least two component carriers of said aggregated component carriers bear a common position reference signal. The carrier aggregated signal has a respective bandwidth. The user equipment comprises processing circuitry to receive said carrier aggregated signal; set a respective sampling period according to said bandwidth of the carrier aggregated signal; and sample the carrier aggregated signal, at the respective sampling period, across a bandwidth associated with said at least two component carriers. The carrier aggregated signal can be, or is, an intra-band contiguous component carrier signal.

The processing circuitry to set the respective sampling period according to said carrier aggregated signal is configured, or comprises processing circuitry, to set the sampling period with the bandwidth of said carrier aggregated signal.

Embodiments of such user equipment can be realised in which the carrier aggregated signal comprises at least one position reference signal. The user equipment can be realised in which the carrier aggregated signal comprises at least two position reference signals spanning a contiguous bandwidth and wherein said processing circuitry to set the sampling period according to said carrier aggregated signal comprises processing circuitry to select a sampling period related to the contiguous bandwidth.

Additionally, or alternatively, embodiments of user equipment can be realised in which the processing circuitry to set the sampling period according to said carrier aggregated signal comprises processing circuitry to set the sampling period proportionally to the contiguous bandwidth of the carrier aggregated signal.

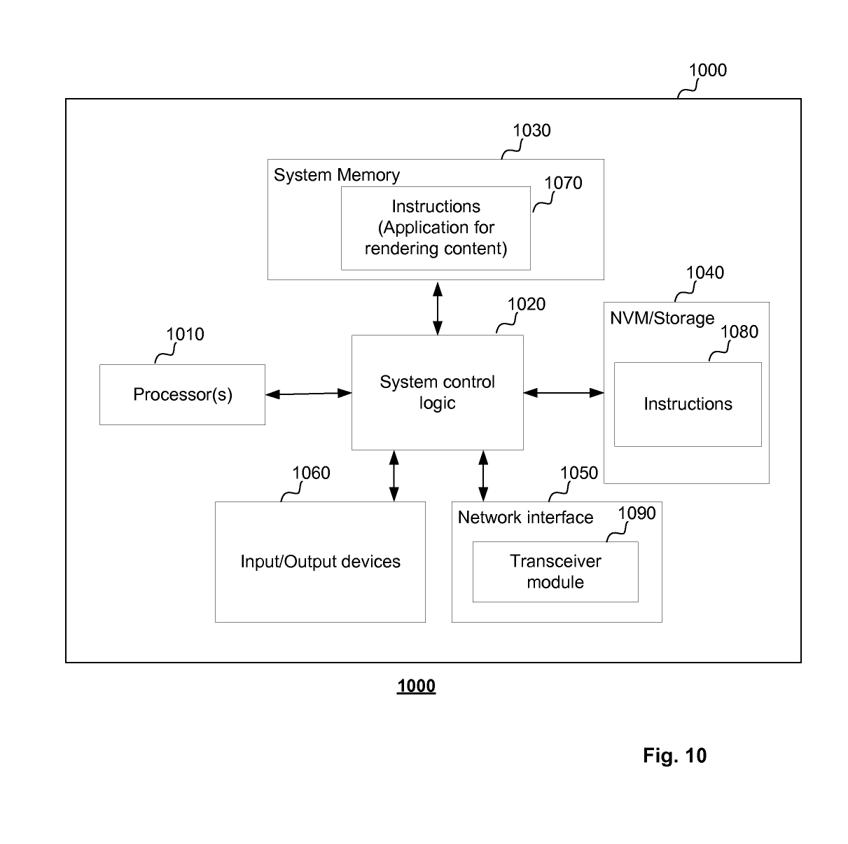

FIG. 10 illustrates, for one embodiment, an example system 1000 for realising a UE 110 as described herein. The system 1000 comprises one or more processor(s) 1010, system control logic 1020 coupled with at least one of the processor(s) 1010, system memory 1030 coupled with system control logic 1020, non-volatile memory (NVM)/storage 1040 coupled with system control logic 1020, and a network interface 1050 coupled with system control logic 1020. The system control logic 1020 may also be coupled to Input/Output devices 1060. The system can be arranged to receive and process one or more than one instance of the positioning signals 114 using intra-band aggregated component carriers as described herein.

Processor(s) 1010 may include one or more single-core or multi-core processors. Processor(s) 1010 may include any combination of general-purpose processors and/or dedicated processors (e.g., graphics processors, application processors, baseband processors, etc.). Processors 1010 may be operable to carry out the above described signal processing using suitable instructions or programs (i.e. operate via use of processor, or other logic, instructions). The instructions may be stored in system memory 1030, as system memory instructions 1070, or, additionally or alternatively, may be stored in (NVM)/storage 1040, as NVM instructions 1080.

System control logic 1020, for one embodiment, may include any suitable interface controllers to provide for any suitable interface to at least one of the processor(s) 1010 and/or to any suitable device or component in communication with system control logic 1020.

System control logic 1020, for one embodiment, may include one or more memory controller(s) to provide an interface to system memory 1030. System memory 1030 may be used to load and store data and/or instructions for system 1000. A system memory 1030, for one embodiment, may include any suitable volatile memory, such as suitable dynamic random access memory (DRAM), for example.

NVM/storage 1040 may include one or more than one tangible, non-transitory computer-readable medium used to store data and/or instructions, for example. NVM/storage 1040 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example.

The NVM/storage 1040 may include a storage resource that is physically part of a device on which the system 1000 is installed or it may be accessible by, but not necessarily a part of, the system 1000. For example, the NVM/storage 1040 may be accessed over a network via the network interface 1050.

System memory 1030 and NVM/storage 1040 may respectively include, in particular, temporal and persistent, that is, non-transient, copies of, for example, the instructions 1070 and 1080, respectively. Instructions 1070 and 1080 may include instructions that when executed by at least one of the processor(s) 1010 result in the system 1000 implementing the processing described above with reference to FIGS. 1 to 17 taken jointly and severally in any and all permutations, or the method(s) of any other embodiment, as described herein. In some embodiments, instructions 1070 and 1080, or hardware, firmware, and/or software components thereof, may additionally/alternatively be located in the system control logic 1020, the network interface 1050, and/or the processor(s) 1010.

Network interface 1050 may have a transceiver module 1090 to provide a radio interface for system 1000 to communicate over one or more network(s) (e.g. wireless communication network) and/or with any other suitable device. The transceiver 1090 may be implement receiver module that performs the above processing of the received signals to realise interference mitigation. In various embodiments, the transceiver 1090 may be integrated with other components of system 1000. For example, the transceiver 1090 may include a processor of the processor(s) 1010, memory of the system memory 1030, and NVM/Storage of NVM/Storage 1040. Network interface 1050 may include any suitable hardware and/or firmware. Network interface 1050 may be operatively coupled to the antenna, or to one or more than one antenna to provide SISO or a multiple input, multiple output radio interface. Network interface 1050 for one embodiment may include, for example, a network adapter, a wireless network adapter, a telephone modem, and/or a wireless modem.

For one embodiment, at least one of the processor(s) 1010 may be packaged together with logic for one or more controller(s) of system control logic 1020. For one embodiment, at least one of the processor(s) 1010 may be packaged together with logic for one or more controllers of system control logic 1020 to form a System in Package (SiP). For one embodiment, at least one of the processor(s) 1040 may be integrated on the same die with logic for one or more controller(s) of system control logic 1020. For one embodiment, at least one of the processor(s) 1010 may be integrated on the same die with logic for one or more controller(s) of system control logic 1020 to form a System on Chip (SoC).

In various embodiments, the I/O devices 1060 may include user interfaces designed to enable user interaction with the system 1000, peripheral component interfaces designed to enable peripheral component interaction with the system 1000, and/or sensors designed to determine environmental conditions and/or location information related to the system 1000.

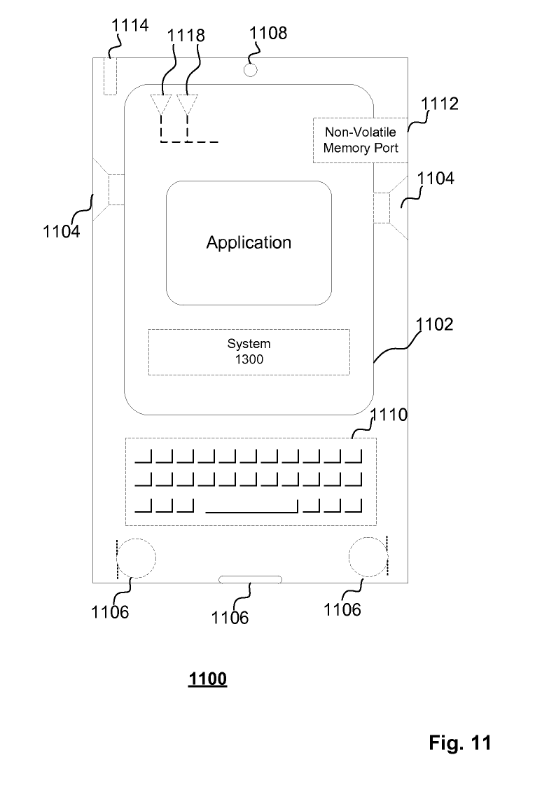

FIG. 11 shows an embodiment in which the system 1000 is used to realise a UE such as UE 110. Such a user equipment 110 can be realised in form of a mobile device 1100.

In various embodiments, user interfaces of the mobile device 1100 could include, but are not limited to, a display 1102 (e.g., a liquid crystal display, a touch screen display, etc.), a speaker 1104, a microphone 1106, one or more cameras 1108 (e.g., a still camera and/or a video camera), a flashlight (e.g., a light emitting diode flash), and a keyboard 1110 taken jointly and severally in any and all combinations.

In various embodiments, one or more than one peripheral component interface may be provided including, but not limited to, a non-volatile memory port 1112, an audio jack 1114, and a power supply interface 1116.

In various embodiments, one or more sensors may be provided including, but not limited to, a gyro sensor, an accelerometer, a proximity sensor, an ambient light sensor, and a positioning unit taken jointly and severally in any and all permutations. The positioning unit may also be part of, or interact with, the network interface 1050 to communicate with components of a positioning network, e.g., a global positioning system (GPS) satellite.

In various embodiments, the system 1100 may be a mobile computing device such as, but not limited to, a laptop computing device, a tablet computing device, a netbook, a mobile phone, etc. In various embodiments, system 1100 may have more or fewer components, and/or different architectures.

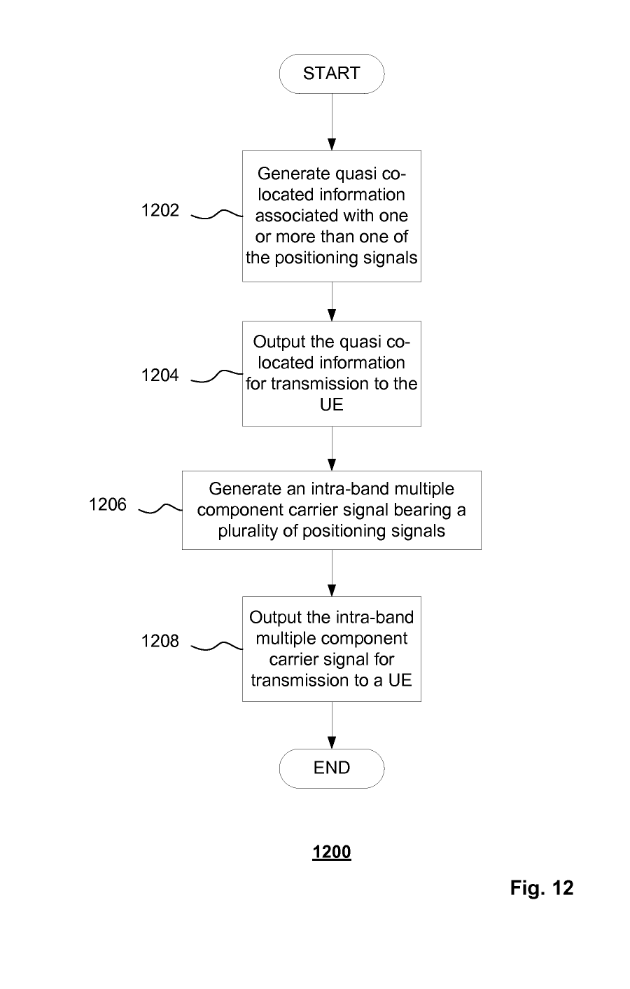

FIG. 12 shows a flowchart 1200 of processing according to an embodiment.

Quasi co-located information associated with the positioning signals is generated at 1202. The quasi co-located information comprises data indicating which positioning signals of a plurality of positioning signals are quasi co-located and could, therefore, be processed as such, for example, to determine one or more than one physical characteristic as described herein. A location server 112 transmits, at 1204, the quasi co-location information to a UE such as, for example, the above described UE 110 via a respective eNB.

The eNB can be any one or more of the eNBs described in this specification. The eNB generates, at 1206, a signal bearing multiple instances of a positioning signal. The positioning signal or signals can be conveyed using carrier aggregation. Embodiments can be realised in which the signal is an intra-band multiple component carrier signal where each component carrier bears a respective positioning signal. Embodiments can be realised in which the signal is an intra-band contiguous component carrier signal. The positioning signal can be a PRS signal, a CRS signal, a combination of at least one PRS signal and at least one CRS signal, or some other reference signal. The eNB can construct the multiple component carrier signal using carrier aggregation to produce a carrier aggregated multiple component carrier signal bearing a plurality of positioning signals.

The multiple component carriers are output for transmission to a UE at 1208. The UE is an embodiment of any of the UEs described in this specification. The multiple component carriers can be transmitted on respective component carriers using carrier aggregation.

As indicated above, the quasi co-location information establishes which positioning signals can be considered to be quasi co-located with respect to one or more than one physical characteristic as described herein.

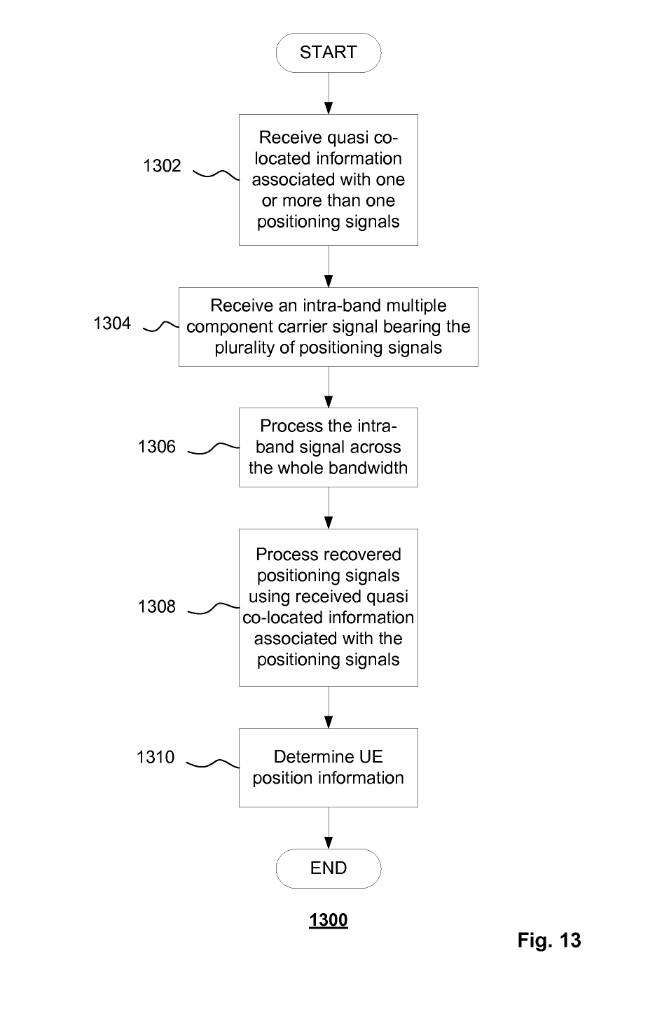

FIG. 13 shows a flowchart 1300 of processing performed by a UE according to an embodiment. The UE can be any of the UEs described herein.

Quasi co-location information is received at 1302 by the UE. The quasi co-located information is associated with two or more of the plurality of positioning signals and provides an indication of which of the plurality of positioning signals can be treated as being quasi co-located with respect to one or more parameters such as, for example, one or more than one physical characteristic described herein.

At 1304, a multiple component carrier signal bearing a plurality of positioning signals is received from an eNB. The positioning signals can comprise one or more of at least one PRS signal, at least one CRS signal or some other reference signal taken jointly and severally in any and all combinations. Embodiments can be realised in which the multiple component carrier signal is an intra-band multiple component carrier signal, optionally produced using carrier aggregation.

The multiple component carrier signal is processed by the UE at 1306. The processing can comprise sampling the signal across the whole of its bandwidth, which is a greater bandwidth than that corresponding to a single instance of a positioning signal. Alternatively, or additionally, the bandwidth across which sampling is performed is a bandwidth that is greater than the bandwidth of single PRS signal or single component carrier together with a lower sampling period that decreases with increasing bandwidth.

Position information associated with the UE is derived at 1310 from at least one of the plurality of positioning signals and the quasi co-location information. Optionally, the positioning information is transmitted to at least one of an eNB, location server, or some other network entity taken jointly and severally in any and all permutations.

While the following detailed description may describe example implementations in relation to broadband wireless wide area networks (WWANs), the examples are not limited thereto and can be applied to other types of wireless networks where similar advantages may be obtained. Such networks specifically include, if applicable, wireless local area networks (WLANs), wireless personal area networks (WPANs) and/or wireless metropolitan area networks (WMANs) such. Further, while specific embodiments may be described in reference to wireless networks utilizing Orthogonal Frequency Division Multiplexing (OFDM) or multi-user OFDM, otherwise referred to as Orthogonal Frequency Division Multiple Access (OFDMA), the embodiments of present invention are not limited thereto and, for example, can be implemented using other air interfaces including single carrier communication channels or a combination of protocols or air interfaces where suitably applicable.

Example implementations can be used in a variety of applications including transmitters and receivers of a radio system, although the example implementations are not limited in this respect. Radio systems specifically included within the scope of the present invention include, but are not limited to, network interface cards (NICs), network adaptors, fixed or mobile client devices, relays, base stations, femtocells, gateways, bridges, hubs, routers, access points, or other network devices. Further, the radio systems within the scope of the invention may be implemented in cellular radiotelephone systems, satellite systems, two-way radio systems as well as computing devices including such radio systems including personal computers (PCs), tablets and related peripherals, personal digital assistants (PDAs), personal computing accessories, hand-held communication devices and all systems which may be related in nature and to which the principles of the embodiments could be suitably applied.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

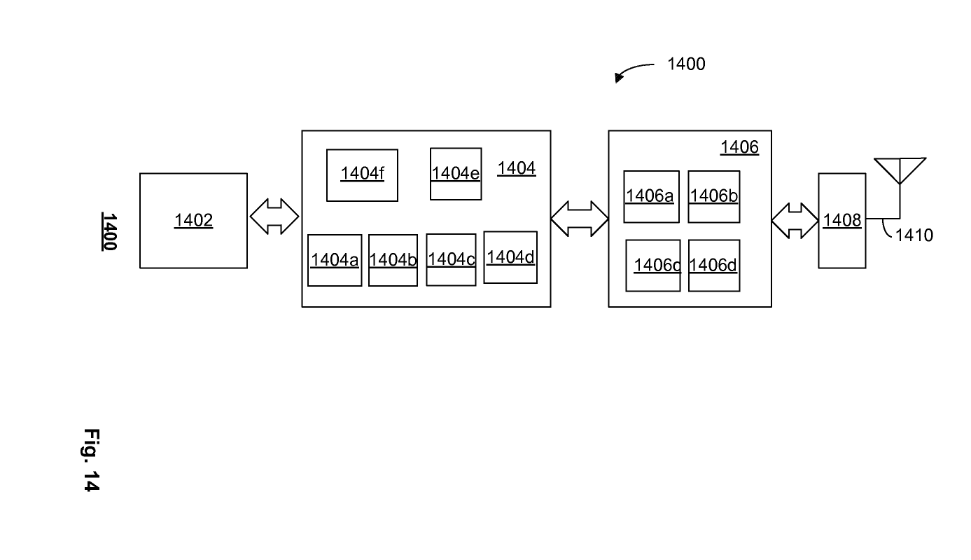

Embodiments described herein may be implemented into a system using any suitably configured hardware and/or software. FIG. 14 illustrates, for one embodiment, example components of a User Equipment (UE) device 1400. In some embodiments, the UE device 1400 may include application circuitry 1402, baseband circuitry 1404, Radio Frequency (RF) circuitry 1406, front-end module (FEM) circuitry 1408 and one or more antennas 1410, coupled together at least as shown.

The application circuitry 1402 may include one or more application processors. For example, the application circuitry 1402 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 1404 may include circuitry such as, but not limited to, one or more single-core or multi-core processors. The baseband circuitry 1404 may include one or more baseband processors and/or control logic to process baseband signals received from a receive signal path of the RF circuitry 1406 and to generate baseband signals for a transmit signal path of the RF circuitry 1406. Baseband processing circuitry 1404 may interface with the application circuitry 1402 for generation and processing of the baseband signals and for controlling operations of the RF circuitry 1406. For example, in some embodiments, the baseband circuitry 1404 may include a second generation (2G) baseband processor 1404a, third generation (3G) baseband processor 1404b, fourth generation (4G) baseband processor 1404c, and/or other baseband processor(s) 1404d for other existing generations, generations in development or to be developed in the future (e.g., fifth generation (5G), 6G, etc.). The baseband circuitry 1404 (e.g., one or more of baseband processors 1404a-d) may handle various radio control functions that enable communication with one or more radio networks via the RF circuitry 1406. The radio control functions may include, but are not limited to, signal modulation/demodulation, encoding/decoding, radio frequency shifting, etc. In some embodiments, modulation/demodulation circuitry of the baseband circuitry 1404 may include Fast-Fourier Transform (FFT), precoding, and/or constellation mapping/demapping functionality. In some embodiments, encoding/decoding circuitry of the baseband circuitry 1404 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1404 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 1404e of the baseband circuitry 1404 may be configured to run elements of the protocol stack for signaling of the PHY, MAC, RLC, PDCP and/or RRC layers. In some embodiments, the baseband circuitry may include one or more audio digital signal processor(s) (DSP) 1404f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1404 and the application circuitry 1402 may be implemented together such as, for example, on a system on a chip (SOC).

In some embodiments, the baseband circuitry 1404 may provide for communication compatible with one or more radio technologies. For example, in some embodiments, the baseband circuitry 1404 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 1404 is configured to support radio communications of more than one wireless protocol may be referred to as multi-mode baseband circuitry.

RF circuitry 1406 may enable communication with wireless networks using modulated electromagnetic radiation through a non-solid medium. In various embodiments, the RF circuitry 1406 may include switches, filters, amplifiers, etc. to facilitate the communication with the wireless network. RF circuitry 1406 may include a receive signal path which may include circuitry to down-convert RF signals received from the FEM circuitry 1408 and provide baseband signals to the baseband circuitry 1404. RF circuitry 1406 may also include a transmit signal path which may include circuitry to up-convert baseband signals provided by the baseband circuitry 1404 and provide RF output signals to the FEM circuitry 1408 for transmission.

In some embodiments, the RF circuitry 1406 may include a receive signal path and a transmit signal path. The receive signal path of the RF circuitry 1406 may include mixer circuitry 1406a, amplifier circuitry 1406b and filter circuitry 1406c. The transmit signal path of the RF circuitry 1406 may include filter circuitry 1406c and mixer circuitry 1406a. RF circuitry 1406 may also include synthesizer circuitry 1406d for synthesizing a frequency for use by the mixer circuitry 1406a of the receive signal path and the transmit signal path. In some embodiments, the mixer circuitry 1406a of the receive signal path may be configured to down-convert RF signals received from the FEM circuitry 1408 based on the synthesized frequency provided by synthesizer circuitry 1406d. The amplifier circuitry 1406b may be configured to amplify the down-converted signals and the filter circuitry 1406c may be a low-pass filter (LPF) or band-pass filter (BPF) configured to remove unwanted signals from the down-converted signals to generate output baseband signals. Output baseband signals may be provided to the baseband circuitry 1404 for further processing. In some embodiments, the output baseband signals may be zero-frequency baseband signals, although this is not a requirement. In some embodiments, mixer circuitry 1406a of the receive signal path may comprise passive mixers, although the scope of the embodiments is not limited in this respect.

In some embodiments, the mixer circuitry 1406a of the transmit signal path may be configured to up-convert input baseband signals based on the synthesized frequency provided by the synthesizer circuitry 1406d to generate RF output signals for the FEM circuitry 1408. The baseband signals may be provided by the baseband circuitry 1404 and may be filtered by filter circuitry 1406c. The filter circuitry 1406c may include a low-pass filter (LPF), although the scope of the embodiments is not limited in this respect.

In some embodiments, the mixer circuitry 1406a of the receive signal path and the mixer circuitry 1406a of the transmit signal path may include two or more mixers and may be arranged for quadrature downconversion and/or upconversion respectively. In some embodiments, the mixer circuitry 1406a of the receive signal path and the mixer circuitry 1406a of the transmit signal path may include two or more mixers and may be arranged for image rejection (e.g., Hartley image rejection). In some embodiments, the mixer circuitry 1406a of the receive signal path and the mixer circuitry 1406a may be arranged for direct downconversion and/or direct upconversion, respectively. In some embodiments, the mixer circuitry 1406a of the receive signal path and the mixer circuitry 1406a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1406 may include analog-to-digital converter (ADC) and digital-to-analog converter (DAC) circuitry and the baseband circuitry 1404 may include a digital baseband interface to communicate with the RF circuitry 1406.

In some dual-mode embodiments, a separate radio IC circuitry may be provided for processing signals for each spectrum, although the scope of the embodiments is not limited in this respect.

In some embodiments, the synthesizer circuitry 1406d may be a fractional-N synthesizer or a fractional N/N−1 synthesizer, although the scope of the embodiments is not limited in this respect as other types of frequency synthesizers may be suitable. For example, synthesizer circuitry 1406d may be a delta-sigma synthesizer, a frequency multiplier, or a synthesizer comprising a phase-locked loop with a frequency divider.

The synthesizer circuitry 1406d may be configured to synthesize an output frequency for use by the mixer circuitry 1406a of the RF circuitry 1406 based on a frequency input and a divider control input. In some embodiments, the synthesizer circuitry 1406d may be a fractional N/N+1 synthesizer.

In some embodiments, frequency input may be provided by a voltage controlled oscillator (VCO), although that is not a requirement. Divider control input may be provided by either the baseband circuitry 1404 or the applications processor 1402 depending on the desired output frequency. In some embodiments, a divider control input (e.g., N) may be determined from a look-up table based on a channel indicated by the applications processor 1402.

Synthesizer circuitry 1406d of the RF circuitry 1406 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N−1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1406d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 1406 may include an IQ/polar converter.

FEM circuitry 1408 may include a receive signal path which may include circuitry configured to operate on RF signals received from one or more antennas 1410, amplify the received signals and provide the amplified versions of the received signals to the RF circuitry 1406 for further processing. FEM circuitry 1408 may also include a transmit signal path which may include circuitry configured to amplify signals for transmission provided by the RF circuitry 1406 for transmission by one or more of the one or more antennas 1410.

In some embodiments, the FEM circuitry 1408 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1406). The transmit signal path of the FEM circuitry 1408 may include a power amplifier (PA) to amplify input RF signals (e.g., provided by RF circuitry 1406), and one or more filters to generate RF signals for subsequent transmission (e.g., by one or more of the one or more antennas 1410.

In some embodiments, the UE device 1400 may include additional elements such as, for example, memory/storage, display, camera, sensor, and/or input/output (I/O) interface.

It will be appreciated that embodiments can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or machine readable storage such as, for example, DVD, memory stick or solid state medium. It will be appreciated that the storage devices and storage media are embodiments of non-transitory machine-readable storage that are suitable for storing a program or programs comprising instructions that, when executed, implement embodiments described and claimed herein. Accordingly, embodiments provide machine executable code for implementing a system, device, user equipment, base station, eNB or method as described herein or as claimed herein and machine readable storage storing such code. Still further, such programs or code may be conveyed electronically via any medium such as a communication signal carried over a wired or wireless connection and embodiments suitably encompass the same.

Embodiments recognize that the use of a QCL assumption of antenna ports by a UE can reduce signalling overhead and time used for channel estimation and/or time/frequency synchronization. The QCL of antenna ports is defined as: a port (Port A) is considered to be quasi co-located with another port (Port B) if the UE is allowed to derive the “large scale channel properties” of Port A, (e.g., needed for channel estimation/time-frequency synchronization based on Port A) from measurement on Port B. For example, these large scale channel properties may include one or more of: delay spread, Doppler spread, frequency shift, average received power (may only be needed between ports of the same type), and received timing.

It will be appreciated that if two antenna ports are quasi co-located, the UE may assume that large-scale properties of the channel over which a symbol on one antenna port is conveyed can be inferred from the channel over which a symbol on the other antenna port is conveyed. For example, the large-scale properties in the above definition may include one or more of: delay spread, Doppler spread, Doppler shift, average gain, and average delay. For the purpose of definition of quasi co-location channel properties: the term “channel” in the above definition includes all the effects and transformations occurring after the corresponding antenna port as defined in 3GPP TS 36.211, which is expressly incorporated by reference herein, including impairments and non-idealities of the radio equipment from eNB; antenna ports may be assumed to be ideally synchronized in time and frequency; and non-idealities in the RF chain as well as the network's intended control of Tx delay, Tx frequency shift, and Tx power difference of the transmit signal as compared to the nominal value are included in this channel model.

Suitably, embodiments can be realised that advantageously provide, in addition to mobile telephony and data, LTE-Advanced (LTE-A) positioning services and positioning data. Since cellular signals have higher receive powers relative to GNSS signals, LTE-A based location services can offer, via embodiments, a solution to the above FCC requirements.

Embodiments can be realised according to one or more than one of the following clauses, taken jointly and severally in any and all combinations:

Clause 1. A system for generating positioning signals for a user equipment; the system comprising processing circuitry to

select a position reference signal for use by the user equipment in determining user equipment position;

produce an aggregated signal comprising a plurality of instances of the position reference signal arranged spanning in a contiguous bandwidth; the contiguous bandwidth being greater than the bandwidth of the position reference signal; and

output the aggregated signal for transmission to the user equipment.

Clause 2. The system of clause 1, further comprising processing circuitry configured to produce quasi co-located information associated with at least a subset of position reference signals of the plurality of position reference signals.

Clause 3. The system of clause 2, wherein the processing circuitry configured to produce quasi co-located information associated with at least the subset of position reference signals of the plurality of position reference signals is configured to produce quasi co-located information associated with at least a pair of position reference signals of the plurality of position reference signals.

Clause 4. The system of clause 2, wherein said processing circuitry configured to produce quasi co-located information is configured to identify at least a cell having one or more than one signal or potential signal that is quasi co-located with one or more than one corresponding signal associated with at least another cell.

Clause 5. The system of any of clauses 1 to 4, wherein said processing circuitry configured to produce the aggregated signal is configured to produce an intra-band component carrier signal having an instance of the position reference signal associated with at least two component carriers of a plurality of component carriers.

Clause 6. The system of any of clauses 1 to 5, wherein said processing circuitry configured to output the aggregated signal is configured to produce a carrier aggregated signal; the carrier aggregated signal being an intra-band contiguous component carrier aggregated signal.

Clause 7. The system of any of clauses 1 to 6, wherein the position reference signal comprises at least one of an LTE reference signal, a position reference sequence signal and a cell specific reference signal.

A system for generating positioning signals for a user equipment; the system comprising processing circuitry configured to

select a position reference signal for use by the user equipment in determining user equipment position;

produce an aggregated signal comprising a plurality of instances of the position reference signal;

produce quasi co-located information associated with at least a subset of position reference signals of the plurality of instances of the position reference signal; and

output the aggregated signal and quasi co-located information for transmission to the user equipment.

Clause 9. The system of clause 8, wherein said processing circuitry configured to produce said aggregated signal is configured to produce a plurality of instances of the position reference signal spanning a contiguous bandwidth; the contiguous bandwidth being greater than the bandwidth of the selected position reference signal.

Clause 10. The system of either of clauses 8 and 9, wherein said processing circuitry configured to produce the quasi co-located information associated with at least the subset of position reference signals of the plurality of position reference signals is configured to produce quasi co-located information associated with at least a pair of position reference signals of the plurality of position reference signals.

Clause 11. The system of any of clauses 8 to 10, wherein said processing circuitry configured to produce quasi co-located information is configured to identify at least a cell having one or more than one signal or potential signal that is quasi co-located with one or more than one corresponding signal associated with at least another cell.

Clause 12. The system of clause 9, wherein said processing circuitry configured to produce the aggregated signal is configured to produce an intra-band component carrier signal having an instance of the position reference signal associated with at least two component carriers of a plurality of component carriers.

Clause 13. The system of either of clauses 9 and 12, wherein said processing circuitry configured to output the aggregated signal is configured to produce a carrier aggregated signal; the carrier aggregated signal being an intra-band contiguous component carrier aggregated signal.

Clause 14. A user equipment (UE) for determining UE location; the user equipment comprising processing circuitry configured to receive an aggregated signal comprising at least one of

a plurality of instances of a position reference signal arranged in or spanning a contiguous bandwidth; the contiguous bandwidth being greater than the bandwidth of the position reference signal; and

a plurality of instances of a position reference signal and quasi co-located information associated with at least a subset of position reference signals of the plurality of instances of the position reference signal;

process the aggregated signal; and

derive location measurement data from said processed aggregated signal.

Clause 15. The user equipment of clause 14, wherein said processing circuitry comprises processing circuitry configured to produce data for one or more than one physical characteristic associated with the subset of position reference signals from said subset of position reference signals and said quasi co-location information.

Clause 16. The user equipment of either of clauses 14 and 15, wherein said processing circuitry configured to produce data is configured to derive an estimate of the one or more than one physical characteristic from the subset of position reference signals and quasi co-location information.

Clause 17. The user equipment of clause 15, wherein the one or more than one physical characteristic comprises one or more than one large-scale properties of a channel associated with the position reference signals.

Clause 18. The user equipment of any of clauses 14 to 17, wherein said processing circuitry is configured to sample the aggregated signal across at least a portion of the contiguous bandwidth; the portion being greater than the bandwidth of the position reference signal.

Clause 19. The user equipment of any of clauses 14 to 18, wherein the one or more than one physical characteristic comprises at least one of delay spread, Doppler spread, Doppler shift, average gain and average delay.

Clause 20. The user equipment of any of clauses 14 to 19, wherein the position reference signal comprises at least one of an LTE reference signal, a position reference sequence signal and a cell specific reference signal.

Clause 21. A carrier aggregated multiple component carrier signal, wherein two or more component carriers bear respective position reference sequence signals.

Clause 22. The signal of clause 21, wherein all component carriers of the multiple component carriers bear respective position reference signals.

Clause 23. The signal of either of clauses 21 and 22, wherein the bandwidth of the component carriers is greater than the bandwidth of a position reference signal.

Clause 24. The signal of any of clauses 21 to 23, wherein signal is an intra-band contiguous component carrier signal.

Clause 25. A PRS-Info data structure for use in position determination of a user equipment; the PRS-Info data structure comprising cell identification data associated with a cell having a quasi co-located transmission corresponding to a further transmission associated with the PRS-Info data structure.

Clause 26. The PRS-Info data structure of clause 25, wherein the quasi co-located transmission is at least one of a positioning reference signal and a cell specific reference signal.

Clause 27. The PRS-Info data structure of either of clauses 25 and 26, wherein the further transmission is at least one of a positioning reference signal and a cell specific reference signal.

Clause 28. A system of positioning reference signal transmission in long term evolution-advanced (LTE-A), wherein the system comprises processing circuitry configured to: signal, by an electronic device, of at least two PRS configurations (IE PRS-Infor) for observed time difference of arrival (OTDOA) measurements; signal, by the electronic device, the quasi co-location information between configured PRS; and perform, by the electronic device, one or more location measurements using configured PRS.

Clause 29. The system of clause 28, wherein the processing circuitry configured to signal quasi co-location information of PRS is configured to signal of the physical cell identity of the cell with quasi co-located PRS transmission.

Clause 30. The system of either of clauses 28 and 29, wherein a user equipment may assume the same average delay between PRS and PRS transmitted from the cell with indicated physical cell identity.

Clause 31. The system of any of clauses 28 to 30, wherein UE may assume the same average gain between PRS and PRS transmitted from the cell with indicated physical cell identity.

Clause 32. The system of any of clauses 28 to 31, wherein the processing circuitry configured to signal quasi co-location information of PRS is configured to signal of a quasi co-located PRS index.

Clause 33. The system of any of clauses 28 to 32, wherein the processing circuitry configured to signal quasi co-location information of PRS is configured to signal a carrier index with quasi co-located PRS.

Clause 34. The system of any of clauses 28 to 32, wherein the electronic device is one or more of an evolved NodeB (eNB), a user equipment (UE), and/or some other electronic device.

Clause 35. A non-transitory machine readable medium for generating positioning signals for a user equipment; the non-transitory machine readable medium comprising instructions arranged when executed to configure processing circuitry to

selecting a position reference signal for use by the user equipment in determining user equipment position;

producing an aggregated signal comprising a plurality of instances of the position reference signal arranged spanning in a contiguous bandwidth; the contiguous bandwidth being greater than the bandwidth of the position reference signal; and

outputting the aggregated signal for transmission to the user equipment.

Clause 36. The non-transitory machine readable medium of clause 35, further comprising instructions to configure processing circuitry to produce quasi co-located information associated with at least a subset of position reference signals of the plurality of position reference signals.

Clause 37. The non-transitory machine readable medium of clause 36, wherein said instructions for configuring processing circuitry to produce quasi co-located information associated with at least the subset of position reference signals of the plurality of position reference signals comprise instructions to configure processing circuitry to produce quasi co-located information associated with at least a pair of position reference signals of the plurality of position reference signals.

Clause 38. The non-transitory machine readable medium of either of clauses 36 and 37, wherein said instructions for configuring processing circuitry to produce quasi co-located information comprises instructions for configuring processing circuitry to identify at least a cell having one or more than one signal or potential signal that is quasi co-located with one or more than one corresponding signal associated with at least another cell.

Clause 39. The non-transitory machine readable medium of any of clauses 35 to 38, wherein the instructions for configuring processing circuitry to produce the aggregated signal comprises instructions arranged to configure processing circuitry to produce an intra-band component carrier signal having an instance of the position reference signal associated with at least two component carriers of a plurality of component carriers.

Clause 40. The non-transitory machine readable medium of any of clauses 35 to 39, wherein the instructions for configuring the processing circuitry to output the aggregated signal comprises instructions to configure processing circuitry to produce a carrier aggregated signal; the carrier aggregated signal being an intra-band contiguous component carrier aggregated signal.

Clause 41. The non-transitory machine readable medium of any of clauses 35 to 40, wherein the position reference signal comprises at least one of an LTE reference signal, a position reference sequence signal and a cell specific reference signal.

Clause 42. A non-transitory machine readable medium for generating positioning signals for a user equipment; the non-transitory machine readable medium comprising instructions arranged when executed to configure processing circuitry to

select a position reference signal for use by the user equipment in determining user equipment position;

produce an aggregated signal comprising a plurality of instances of the position reference signal;

produce quasi co-located information associated with at least a subset of position reference signals of the plurality of instances of the position reference signal; and

output the aggregated signal and quasi co-located information for transmission to the user equipment.

Clause 43. The non-transitory machine readable medium of clause 42, wherein said instructions to configure processing circuitry to produce said aggregated signal comprises instructions to configure processing circuitry to produce a plurality of instances of the position reference signal spanning a contiguous bandwidth; the contiguous bandwidth being greater than the bandwidth of the selected position reference signal.

Clause 44. The non-transitory machine readable medium of either of clauses 42 to 43, wherein said instruction to configure processing circuitry to produce the quasi co-located information associated with at least the subset of position reference signals of the plurality of position reference signals comprises instructions to configure processing circuitry to produce quasi co-located information associated with at least a pair of position reference signals of the plurality of position reference signals.

Clause 45. The non-transitory machine readable medium of any of clauses 42 to 44, wherein said instructions to configure processing circuitry to produce quasi co-located information comprise instructions to configure processing circuitry to identify at least a cell having one or more than one signal or potential signal that is quasi co-located with one or more than one corresponding signal associated with at least another cell.

Clause 46. The non-transitory machine readable medium of clause 43, wherein said instructions to configure processing circuitry to produce the aggregated signal comprises instructions to configure processing circuitry to produce an intra-band component carrier signal having an instance of the position reference signal associated with at least two component carriers of a plurality of component carriers.

Clause 47. The non-transitory machine readable medium of either of clauses 43 and 44, wherein said instructions for configuring processing circuitry to output the aggregated signal comprise instructions to configure processing circuitry to produce a carrier aggregated signal; the carrier aggregated signal being an intra-band contiguous component carrier aggregated signal.

Clause 48. A non-transitory machine readable medium for determining UE location; the non-transitory machine readable medium comprising instructions arranged when executed to configure processing circuitry to

receive an aggregated signal comprising at least one of

a plurality of instances of a position reference signal arranged in or spanning a contiguous bandwidth; the contiguous bandwidth being greater than the bandwidth of the position reference signal; and

a plurality of instances of the position reference signal and quasi co-located information associated with at least a subset of position reference signals of the plurality of instances of the position reference signal; and

process the aggregated signal; and

derive location measurement data from said processed aggregated signal.

Clause 49. The non-transitory machine readable medium of clause 48, wherein instructions to configure processing circuitry to process the aggregated signal comprise instructions to configure processing circuitry to produce data for one or more than one physical characteristic associated with the subset of position reference signals from said subset of position reference signals and said quasi co-location information.

Clause 50. The non-transitory machine readable medium of either of clauses 48 and 49, wherein said instructions to configure processing circuitry to produce data comprise instructions to configure processing circuitry to derive an estimate of the one or more than one physical characteristic from the subset of position reference signals and quasi co-location information.

Clause 51. The non-transitory machine readable medium of clause 50, wherein the one or more than one physical characteristic comprises one or more than one large-scale properties of a channel associated with the position reference signals.

Clause 52. The non-transitory machine readable medium of any of clauses 48 to 51, wherein the instructions to configure processing circuitry to process the aggregated signal comprises instructions to configure processing circuitry to sample the aggregated signal across at least a portion of the contiguous bandwidth; the portion being greater than the bandwidth of the position reference signal.

Clause 53. The non-transitory machine readable medium of any of clauses 48 to 52, wherein the one or more than one physical characteristic comprises at least one of delay spread, Doppler spread, Doppler shift, average gain and average delay.

Clause 54. The non-transitory machine readable medium of any of clauses 48 to 53, wherein the position reference signal comprises at least one of an LTE reference signal, a position reference sequence signal and a cell specific reference signal.

Clause 55. A non-transitory machine readable medium of positioning reference signal transmission in long term evolution-advanced (LTE-A), wherein the non-transitory machine readable medium includes instructions to configure processing circuitry to: signal, by an electronic device, of at least two PRS configurations (IE PRS-Infor) for observed time difference of arrival (OTDOA) measurements; signal, by the electronic device, the quasi co-location information between configured PRS; and perform, by the electronic device, one or more location measurements using configured PRS.

Clause 56. The non-transitory machine readable medium of clause 55, wherein said instructions to configure processing circuitry to signal quasi co-location information of PRS comprise instructions to configure processing circuitry to signal of the physical cell identity of the cell with quasi co-located PRS transmission.

Clause 57. The non-transitory machine readable medium of clause 56, wherein a user equipment may assume the same average delay between PRS and PRS transmitted from the cell with indicated physical cell identity.

Clause 58. The non-transitory machine readable medium of either of clauses 56 and 57, wherein a user equipment may assume the same average gain between PRS and PRS transmitted from the cell with indicated physical cell identity.

Clause 59. The non-transitory machine readable medium of any of clauses 55 to 58, wherein said instructions to configure processing circuitry to signal quasi co-location information of PRS comprise instructions to configure processing circuitry to signal a quasi co-located PRS index.

Clause 60. The non-transitory machine readable medium of any of clauses 55 to 59, wherein said instructions to signal quasi co-location information of PRS include instructions to configure processing circuitry to signal a carrier index with quasi co-located PRS.

Clause 61. The non-transitory machine readable medium of any of clauses 55 to 60, wherein the electronic device is one or more of an evolved NodeB (eNB), a user equipment (UE), and/or some other electronic device.

Clause 62. A method for generating positioning signals for a user equipment; the method comprising

selecting a position reference signal for use by the user equipment in determining user equipment position;

producing an aggregated signal comprising a plurality of instances of the position reference signal arranged spanning in a contiguous bandwidth; the contiguous bandwidth being greater than the bandwidth of the position reference signal; and

outputting the aggregated signal for transmission to the user equipment.

Clause 63. The method of clause 62, further comprising producing quasi co-located information associated with at least a subset of position reference signals of the plurality of position reference signals.

Clause 64. The method of clause 63, wherein said producing quasi co-located information associated with at least the subset of position reference signals of the plurality of position reference signals comprises producing quasi co-located information associated with at least a pair of position reference signals of the plurality of position reference signals.

Clause 65. The method of either of clauses 63 and 64, wherein said producing quasi co-located information comprising identifying at least a cell having one or more than one signal or potential signal that is quasi co-located with one or more than one corresponding signal associated with at least another cell.

Clause 66. The method of any of clauses 62 to 65, wherein producing the aggregated signal comprises producing an intra-band component carrier signal having an instance of the position reference signal associated with at least two component carriers of a plurality of component carriers.

Clause 67. The method of any of clauses 62 to 66, wherein the aggregated signal comprises producing a carrier aggregated signal; the carrier aggregated signal being an intra-band contiguous component carrier aggregated signal.

Clause 68. The method of any of clauses 62 to 67, wherein the position reference signal comprises at least one of an LTE reference signal, a position reference sequence signal and a cell specific reference signal.

Clause 69. A method for generating positioning signals for a user equipment; the method comprising

selecting a position reference signal for use by the user equipment in determining user equipment position;

producing an aggregated signal comprising a plurality of instances of the position reference signal;

producing quasi co-located information associated with at least a subset of position reference signals of the plurality of instances of the position reference signal; and

outputting the aggregated signal and quasi co-located information for transmission to the user equipment.

Clause 70. The method of clause 69, wherein producing said aggregated signal comprises producing a plurality of instances of the position reference signal spanning a contiguous bandwidth; the contiguous bandwidth being greater than the bandwidth of the selected position reference signal.

Clause 71. The method of either of clauses 69 and 70, wherein said producing the quasi co-located information associated with at least the subset of position reference signals of the plurality of position reference signals comprises producing quasi co-located information associated with at least a pair of position reference signals of the plurality of position reference signals.

Clause 72. The method of any of clauses 69 to 71, wherein said producing quasi co-located information comprises identifying at least a cell having one or more than one signal or potential signal that is quasi co-located with one or more than one corresponding signal associated with at least another cell.

Clause 73. The method of any of clauses 69 to 72, wherein producing the aggregated signal comprises producing an intra-band component carrier signal having an instance of the position reference signal associated with at least two component carriers of a plurality of component carriers.

Clause 74. The method of any of clauses 69 to 73, wherein producing the aggregated signal comprises producing a carrier aggregated signal; the carrier aggregated signal being an intra-band contiguous component carrier aggregated signal.

Clause 75. A method for determining UE location; the method comprising

receiving an aggregated signal comprising at least one of

a plurality of instances of a position reference signal arranged in or spanning a contiguous bandwidth; the contiguous bandwidth being greater than the bandwidth of the position reference signal; and

a plurality of instances of a position reference signal and quasi co-located information associated with at least a subset of position reference signals of the plurality of instances of the position reference signal; and

processing the aggregated signal; and

deriving location measurement data from said processed aggregated signal.

Clause 76. The method of clause 75, wherein said processing comprises producing data for one or more than one physical characteristic associated with the subset of position reference signals from said subset of position reference signals and said quasi co-location information.

Clause 77. The method of clause 76, wherein said producing data comprises deriving an estimate of the one or more than one physical characteristic from the subset of position reference signals and quasi co-location information.

Clause 78. The method of either of clauses 76 and 77, wherein the one or more than one physical characteristic comprises one or more than one large-scale properties of a channel associated with the position reference signals.

Clause 79. The method of any of clauses 75 to 78, wherein said processing comprises sampling the aggregated signal across at least a portion of the contiguous bandwidth; the portion being greater than the bandwidth of the position reference signal.

Clause 80. The method of any of clauses 75 to 79, wherein the one or more than one physical characteristic comprises at least one of delay spread, Doppler spread, Doppler shift, average gain and average delay.

Clause 81. The method of any of clauses 75 to 80, wherein the position reference signal comprises at least one of an LTE reference signal, a position reference sequence signal and a cell specific reference signal.

Clause 82. A method of positioning reference signal transmission in long term evolution-advanced (LTE-A), wherein the method includes: signalling, by an electronic device, of at least two PRS configurations (IE PRS-Infor) for observed time difference of arrival (OTDOA) measurements; signalling, by the electronic device, the quasi co-location information between configured PRS; and performing, by the electronic device, one or more location measurements using configured PRS.

Clause 83. The method of clause 82, wherein quasi co-location information of PRS includes signalling of the physical cell identity of the cell with quasi co-located PRS transmission.

Clause 84. The method of clause 83, wherein UE may assume the same average delay between PRS and PRS transmitted from the cell with indicated physical cell identity.

Clause 85. The method of either of clauses 83 and 84, wherein UE may assume the same average gain between PRS and PRS transmitted from the cell with indicated physical cell identity.

Clause 86. The method of any of clauses 83 to 85, wherein quasi co-location information of PRS includes signalling of the quasi co-located PRS index.

Clause 87. The method of any of clauses 82 to 86, wherein quasi co-location information of PRS includes signalling of carrier index with quasi co-located PRS.

Clause 88. The method of any of clauses 82 to 87, wherein the electronic device is one or more of an evolved NodeB (eNB), a user equipment (UE), and/or some other electronic device.

Clause 89. A system, location server or eNB for determining UE position data, comprising means configured to implement, or means for implementing, the method of any of clauses 62 to 88.

Clause 90 A user equipment for processing a reference signal; the user equipment comprising processing circuitry to

receive at least one reference signal; said at least one reference signal having a respective bandwidth;

set a respective sampling period according to said bandwidth of at least one reference signal; and

sample the signal at the a respective sampling period.

Clause 91 The user equipment of clause 90, wherein the processing circuitry to set the respective sampling period according to said at least one reference signal is configured to set the sampling period with the bandwidth of said at least one reference signal.

Clause 92 The user equipment of either of clauses 90 and 91, wherein the at least one reference signal comprises at least one position reference signal.

Clause 93 The user equipment of any preceding clause, wherein the at least one reference signal comprises at least two position reference signals spanning a contiguous bandwidth and wherein said processing circuitry to set the sampling period according to said at least one reference signal comprises processing circuitry to select a sampling period related to the contiguous bandwidth.

Clause 94 The user equipment of any preceding clause, wherein said processing circuitry to set the sampling period according to said at least one reference signal comprises processing circuitry to set the sampling period proportionally to the contiguous bandwidth of the at least one reference signal.

Clause 95 The user equipment of any preceding clause, wherein said processing circuitry to set the sampling period according to said at least one reference signal comprises processing circuitry to select first sampling period associated with a first bandwidth of said at least one reference signal and to select a second sampling period associated with a second bandwidth of said at least one reference signal.

Clause 96 The user equipment of any preceding clause, wherein the first sampling period is twice the second sampling period.

Clause 97 Non-transitory machine readable storage storing machine executable instructions arranged, when executed, to configure processing circuitry to receive at least one reference signal; said at least one reference signal having a respective bandwidth;

set a respective sampling period according to said bandwidth of at least one reference signal; and

sample the signal at the a respective sampling period.

Clause 98 The non-transitory machine readable storage of clause 97, wherein said instructions to configure said processing circuitry to set the sampling period according to said at least one reference signal comprises instructions to set the sampling period with the bandwidth of said at least one reference signal.

Clause 99 The non-transitory machine readable storage of either of clauses 97 and 98, wherein the at least one reference signal comprises at least one position reference signal.

Clause 100 The non-transitory machine readable storage of any of clauses 97 to 99, wherein the at least one reference signal comprises at least two position reference signals spanning a contiguous bandwidth and wherein said processing circuitry to set the sampling period according to said at least one reference signal comprises processing circuitry to select a sampling period related to the contiguous bandwidth.

Clause 101 The non-transitory machine readable storage of any of clauses 97 to 100, wherein instructions arranged to configure said processing circuitry to set the sampling period according to said at least one reference signal comprise instructions arranged to configure said processing circuitry to set the sampling period proportionally to the contiguous bandwidth of the at least one reference signal.

Clause 102 The non-transitory machine readable storage of any of clauses 97 to 101, wherein said instructions arranged to configure said processing circuitry to set the sampling period according to said at least one reference signal comprise instructions arranged to configure processing circuitry to select first sampling period associated with a first bandwidth of said at least one reference signal and to select a second sampling period associated with a second bandwidth of said at least one reference signal.

Clause 103 The non-transitory machine readable storage of clause 102, wherein the first sampling period is twice the second sampling period.

Clause 104 A user equipment for processing a carrier aggregated signal comprising a plurality of aggregated component carriers; at least two component carriers of said aggregated component carriers bearing a common position reference signal; the carrier aggregated signal having a respective bandwidth; Clause The user equipment comprising processing circuitry to

receive said carrier aggregated signal;

set a respective sampling period according to said bandwidth of the carrier aggregated signal; and

sample the carrier aggregated signal, at the respective sampling period, across a bandwidth associated with said at least two component carriers.

Clause 105 The user equipment of clause 104, wherein the carrier aggregated signal is an intra-band contiguous component carrier signal.

Clause 106 The user equipment of either of clauses 104 and 105, wherein the processing circuitry to set the respective sampling period according to said carrier aggregated signal is configured to set the sampling period with the bandwidth of said carrier aggregated signal.

Clause 107 The user equipment of any of clauses 104 to 106, wherein the carrier aggregated signal comprises at least one position reference signal.

Clause 108 The user equipment of any of clauses 104 to 107, wherein the carrier aggregated signal comprises at least two position reference signals spanning a contiguous bandwidth and wherein said processing circuitry to set the sampling period according to said carrier aggregated signal comprises processing circuitry to select a sampling period related to the contiguous bandwidth.

Clause 109 The user equipment of any of clauses 104 to 108, wherein said processing circuitry to set the sampling period according to said carrier aggregated signal comprises processing circuitry to set the sampling period proportionally to the contiguous bandwidth of the carrier aggregated signal.

Clause 110 The user equipment of any of clauses 104 to 109, wherein said processing circuitry to set the sampling period according to said carrier aggregated signal comprises processing circuitry to select first sampling period associated with a first bandwidth of said carrier aggregated signal and to select a second sampling period associated with a second bandwidth of said carrier aggregated signal.

Clause 111 The user equipment of clause 110, wherein the first sampling period is twice the second sampling period.

What is claimed is:

1. A system for generating positioning signals for a user equipment; the system comprising processing circuitry to
a. select a position reference signal for use by the user equipment in determining user equipment position;
b. produce an aggregated signal comprising a plurality of instances of the position reference signal arranged spanning in a contiguous bandwidth; the contiguous bandwidth being greater than the bandwidth of the position reference signal; and
c. output the aggregated signal for transmission to the user equipment.

2. The system of claim 1, further comprising processing circuitry configured to produce quasi co-located information associated with at least a subset of position reference signals of the plurality of position reference signals.

3. The system of claim 2, wherein the processing circuitry configured to produce quasi co-located information associated with at least the subset of position reference signals of the plurality of position reference signals is configured to produce quasi co-located information associated with at least a pair of position reference signals of the plurality of position reference signals.

4. The system of claim 2, wherein said processing circuitry configured to produce quasi co-located information is configured to identify at least a cell having one or more than one signal or potential signal that is quasi co-located with one or more than one corresponding signal associated with at least another cell.

5. The system of claim 1, wherein said processing circuitry configured to produce the aggregated signal is configured to produce an intra-band component carrier signal having an instance of the position reference signal associated with at least two component carriers of a plurality of component carriers.

6. The system of claim 1, wherein said processing circuitry configured to output the aggregated signal is configured to produce a carrier aggregated signal; the carrier aggregated signal being an intra-band contiguous component carrier aggregated signal.

7. The system of claim 1, wherein the position reference signal comprises at least one of an LTE reference signal, a position reference sequence signal and a cell specific reference signal.

8. A user equipment for processing a carrier aggregated signal comprising a plurality of aggregated component carriers; at least two component carriers of said aggregated component carriers bearing a common position reference signal; the carrier aggregated signal having a respective bandwidth; the user equipment comprising processing circuitry to
receive said carrier aggregated signal;
set a respective sampling period according to said bandwidth of the carrier aggregated signal; and
sample the carrier aggregated signal, at the respective sampling period, across a bandwidth associated with said at least two component carriers.

9. The user equipment of claim 8, wherein the carrier aggregated signal is an intra-band contiguous component carrier signal.

10. The user equipment of claim 8, wherein the processing circuitry to set the respective sampling period according to said carrier aggregated signal is configured to set the sampling period with the bandwidth of said carrier aggregated signal.

11. The user equipment of claim 8, wherein the carrier aggregated signal comprises at least one position reference signal.

12. The user equipment of claim 8, wherein the carrier aggregated signal comprises at least two position reference signals spanning a contiguous bandwidth and wherein said processing circuitry to set the sampling period according to said carrier aggregated signal comprises processing circuitry to select a sampling period related to the contiguous bandwidth.

13. The user equipment of claim 8, wherein said processing circuitry to set the sampling period according to said carrier aggregated signal comprises processing circuitry to set the sampling period proportionally to the contiguous bandwidth of the carrier aggregated signal.

14. A user equipment (UE) for determining UE location; the user equipment comprising processing circuitry configured to
a. receive an aggregated signal comprising at least one of
i. a plurality of instances of a position reference signal arranged in or spanning a contiguous bandwidth; the contiguous bandwidth being greater than the bandwidth of the position reference signal; and
ii. a plurality of instances of a position reference signal and quasi co-located information associated with at least a subset of position reference signals of the plurality of instances of the position reference signal;
b. process the aggregated signal; and
c. derive location measurement data from said processed aggregated signal.

15. The user equipment of claim 14, wherein said processing circuitry comprises processing circuitry configured to produce data for one or more than one physical characteristic associated with the subset of position reference signals from said subset of position reference signals and said quasi co-location information.

16. The user equipment of claim 14, wherein said processing circuitry configured to produce data is configured to derive an estimate of the one or more than one physical characteristic from the subset of position reference signals and quasi co-location information.

17. The user equipment of claim 15, wherein the one or more than one physical characteristic comprises one or more than one large-scale properties of a channel associated with the position reference signals.

18. The user equipment of claim 14, wherein said processing circuitry is configured to sample the aggregated signal across at least a portion of the contiguous bandwidth; the portion being greater than the bandwidth of the position reference signal.

19. The user equipment of claim 14, wherein the one or more than one physical characteristic comprises at least one of delay spread, Doppler spread, Doppler shift, average gain and average delay.

20. The user equipment of claim 14, wherein the position reference signal comprises at least one of an LTE reference signal, a position reference sequence signal and a cell specific reference signal.

21. The user equipment of claim 14, comprising at least one of an input device, an output device, a speaker, a keyboard and a display.
